(19) United States
(12) Patent Application Publication
(10) Pub. No.: US 2002/0080170 A1
(43) Pub. Date: Jun. 27, 2002

(54) Information management system

(76) Inventors: Elisha Y. Goldberg, New York, NY (US); Yonah Schmeidler, Cambridge, MA (US); Marc Horowitz, Cambridge, MA (US)

Correspondence Address: DARBY & DARBY, 805 THIRD AVENUE, 27TH FLR., NEW YORK, NY, 10022, US

(21) Appl. No.: 09/803,731

(22) Filed: Mar. 9, 2001

Related U.S. Application Data
(60) Provisional application No. 60/189,076, filed on Mar. 13, 2000.

(51) Int. Cl. G09G 5/00

(52) U.S. Cl. 345/748

(57) ABSTRACT

An information management system including an information source processor operative for performing user-selectable information management processes on any user-selectable information source from among a plurality of information sources and an ELA interface constructed and operative to allow a user to identify specific elements of documents as information sources, wherein the specific elements which a user is allowed to identify include at least one of the following group: image, phrase, table, sub-table, line, caption, cell, row, column, item, list, paragraph, frame.

### FIELD OF THE INVENTION

The present invention relates to apparatus and methods for computerized information management.

### BACKGROUND OF THE INVENTION

Conventional systems for computerized information management are described at the following Internet websites:

www.clickmarks.com

www.verity.com

www.octopus.com

www.snippets.com.

The disclosures of all publications mentioned in the specification and of the publications cited therein are hereby incorporated by reference.

### SUMMARY OF THE INVENTION

The present invention seeks to provide improved systems and methods for information management useful for managing multiple dynamic electronic information sources.

The system of the present invention preferably includes a complete information management system operative to allow users to organize, store, access, search, annotate, share, distribute, monitor and analyze multiple dynamic electronic information sources. Typically, the system includes multiple synergistic components that can be used individually or in conjunction with one another to achieve synergism of the components.

There is thus provided, in accordance with a preferred embodiment of the present invention, an information management system including a plurality of information sources, and an information source previewer operative to provide a preview of the information sources including a less than complete view of at least some of the information sources.

Also provided, in accordance with another preferred embodiment of the present invention, is an information management system including at least one representations of information sources, a graphical user interface integrated with at least one of the representations of the information sources, and an archiving system operative to allow users to time-stamp and archive at least one representations of information sources.

Further in accordance with a preferred embodiment of the present invention, the archiving system is operative to allow remote archiving.

Still further in accordance with a preferred embodiment of the present invention, the archiving system includes an annotator.

Additionally in accordance with a preferred embodiment of the present invention, the graphical user interface allows a user to specify which of a plurality of other users can access the content and how long content is to be stored.

Also provided, in accordance with another preferred embodiment of the present invention, is an information management system including an archiving system operative to allow users to time-stamp and archive content, and a scheduling system allowing the archiving system to operate automatically in accordance with a predetermined schedule.

Further in accordance with a preferred embodiment of the present invention, the scheduling system operates the archiving system in accordance with at least one triggering rule.

Further in accordance with a preferred embodiment of the present invention, the scheduling system is operative to perform a watch function in which predefined content is watched for.

Also provided, in accordance with yet another preferred embodiment of the present invention, is an information management system including a content searcher, a search-defining GUI allowing a user to define a search, and a watch-defining GUI allowing a user to define a watch at least by automatically converting a previously defined search into a watch.

Additionally provided, in accordance with another preferred embodiment of the present invention, is an information management system including a content searcher and a search-defining GUI allowing a user to define at least freshness of search.

Further provided, in accordance with another preferred embodiment of the present invention, is an information management system including a content searcher and a search-defining GUI allowing a user to define at least depth of search.

Also provided, in accordance with another preferred embodiment of the present invention, is an information management system including a content searcher and a search-defining GUI allowing a user to define at least duration of search.

Further provided, in accordance with still another preferred embodiment of the present invention, is an information management system including an information source manager including a set of user-defined information sources, a content searcher, and a search-defining GUI allowing a user to define a subset of the user-defined information sources to be searched.

Additionally provided, in accordance with another preferred embodiment of the present invention, is an information management system including a server storing user-defined folders, and a client via which a user can view at least some of the user-defined folders.

Also provided, in accordance with another preferred embodiment of the present invention, is an information management system including at least one representations of information sources including graphic representation of check-update status, and a check-update status maintainer operative to monitor the check-update status of each information source and to maintain the graphic representation of the check-update status accordingly.

Further provided, in accordance with still another preferred embodiment of the present invention, is an information management system including a search results GUI including a plurality of separate result windows for separate search results.

Also provided, in accordance with still another preferred embodiment of the present invention, is an information management system including a document portion identification GUI operative to allow a user to graphically identify a portion of a document using a targeted set of questions, and a document portion processing unit operative to perform at least one process on a document portion defined by a user via the document portion identification GUI.

Further in accordance with a preferred embodiment of the present invention, the system is operative to perform a search over a specific part of an information source.

Also provided, in accordance with another preferred embodiment of the present invention, is a information management system including a plurality of information management tools, an information source, and a GUI (graphic user interface) integrating the plurality of information management tools around the information source using a graphical representation.

Further in accordance with a preferred embodiment of the present invention, at least one of the information sources is selectably accessed via a locally stored copy thereof rather than directly.

Still further in accordance with a preferred embodiment of the present invention, the scheduling system performs the watch function over a user-defined set of information sources and over a user-defined time period.

Further in accordance with a preferred embodiment of the present invention, the scheduling system includes a notifier operative to notify a user of “hits”, the notifier employing any of a plurality of user-selectable notification modes.

Also provided, in accordance with still another preferred embodiment of the present invention, is an information management system including a watch unit operative to watch for a defined unit of information in a flow of information, and an ELA unit.

Further in accordance with a preferred embodiment of the present invention, the system is operative to perform an ongoing search over a specific part of an information source.

Also provided, in accordance with a preferred embodiment of the present invention, is an information management system including an update checking unit, and an ELA unit.

Further in accordance with a preferred embodiment of the present invention, the system is operative to perform an ongoing update-check over a specific part of an information source.

Still further in accordance with a preferred embodiment of the present invention, the document portion processing unit is programmable to perform customized functions, thereby to allow a user to perform customized processes on specific document portions.

Additionally in accordance with a preferred embodiment of the present invention, the client displays multiple sources simultaneously.

Further in accordance with a preferred embodiment of the present invention, the client operates within a standard web browser without downloading and installing specialized software.

Still further in accordance with a preferred embodiment of the present invention, the search results GUI displays a list of results and, simultaneously, the results themselves in separate windows.

Also provided, in accordance with a preferred embodiment of the present invention, is an information management system including a functional unit operative to perform a plurality of selectable functions on information, and an automatic information retriever operative to automatically retrieve information from a plurality of information sources.

Further in accordance with a preferred embodiment of the present invention, the automatic information retriever is selectably operative to automatically retriever information on a condition-triggered basis.

Still further in accordance with a preferred embodiment of the present invention, the system also includes an ELA unit.

Further in accordance with a preferred embodiment of the present invention, multiple user-selectable notification methods are employed to bring system work products to a user's attention.

Still further in accordance with a preferred embodiment of the present invention, the system also includes an interface allowing mobile access to and control of the system.

Also provided, in accordance with a preferred embodiment of the present invention, is an information management system including an information source processor operative for performing user-selectable information management processes on any user-selectable information source from among a plurality of information sources, and an ELA interface constructed and operative to allow a user to identify specific elements of documents as information sources.

Further in accordance with a preferred embodiment of the present invention, the specific elements which a user is allowed to identify include at least one of the following group: image, phrase, table, sub-table, line, caption, cell, row, column, item, list, paragraph, frame.

Additionally in accordance with a preferred embodiment of the present invention, the ELA interface is operative to group several elements in a document.

Still further in accordance with a preferred embodiment of the present invention, the ELA interface is operative to contiguously group several elements in a document.

Additionally in accordance with a preferred embodiment of the present invention, the ELA interface is operative to non-contiguously group several elements in a document.

Further in accordance with a preferred embodiment of the present invention, a group of at least one elements may be identified by means of a combination of at least one internal properties.

Still further in accordance with a preferred embodiment of the present invention, a group of at least one elements may be identified by means of their relationships to other elements having a specified combination of at least one internal properties.

Further in accordance with a preferred embodiment of the present invention, the internal properties include at least one of the following group: contains a specified text, possesses at least one descriptive formatting property, contains specified markup-tag information.

Still further in accordance with a preferred embodiment of the present invention, the at least one descriptive formatting property includes at least one of the following group of property types: a color property, a size property, and a style property.

Further in accordance with a preferred embodiment of the present invention, the relationships include at least one of the following type of relationships: after, before, between, contained in, location in group, bigger, biggest in group, first, smallest, largest.

Also provided in accordance with a preferred embodiment of the present invention are methods for implementing and employing the systems shown and described herein.

### BRIEF DESCRIPTION OF THE DRAWINGS

The present invention will be understood and appreciated from the following detailed description, taken in conjunction with the drawings in which:

FIG. 1 is a simplified pictorial illustration of a screen display of an “add folder” interface constructed and operative in accordance with a preferred embodiment of the present invention which is useful in implementing a Folder View functionality provided in accordance with a preferred embodiment of the present invention;

FIG. 2 is a simplified pictorial illustration of a screen display of a “folder view” interface constructed and operative in accordance with a preferred embodiment of the present invention;

FIG. 3 is a simplified pictorial illustration of a screen display of an “add source” interface constructed and operative in accordance with a preferred embodiment of the present invention;

FIG. 4 is a detailed illustration of an individual one of the Topic Windows (such as Window 230) illustrated in the screen display of FIG. 2, in a first, Web, mode useful in implementing a Topic Window functionality provided in accordance with a preferred embodiment of the present invention;

FIG. 5 is a detailed illustration of an individual one of the Topic Windows (such as Window 230) illustrated in the screen display of FIG. 2, in a second, Notes, mode useful in implementing the Topic Window functionality, accessed by clicking the Notes button 430 in FIG. 4;

FIG. 6 is a simplified pictorial illustration of a screen display of a “SHOW NOTE” interface constructed and operative in accordance with a preferred embodiment of the present invention, that appears when clicking on an individual note listing 520 in mode 2 (notes) of a topic window, such as that shown in FIG. 5;

FIG. 7 is a detailed illustration of an individual one of the Topic Windows (such as Window 230) illustrated in the screen display of FIG. 2, in a third, Watch, mode useful in implementing the Topic Window functionality, accessed by clicking the Watch button 440 in FIG. 4;

FIG. 8 is a detailed illustration of an individual one of the Topic Windows (such as Window 230) illustrated in the screen display of FIG. 2, in a fourth, Archive, mode useful in implementing the Topic Window functionality, accessed by clicking the Archive button 450 in FIG. 4;

FIG. 9 is a simplified pictorial illustration of a screen display of an “search” interface, accessed through the menus 210 at the top of the screen display in FIG. 2, constructed and operative in accordance with a preferred embodiment of the present invention;

FIG. 10 is a simplified pictorial illustration of a screen display of an “search results” interface, accessed by entering information in the search interface and selecting the “Search” button in FIG. 9, constructed and operative in accordance with a preferred embodiment of the present invention;

FIG. 11 is a simplified pictorial illustration of a screen display of a “watch” interface, accessed through the menus 210 at the top of the screen display in FIG. 2, constructed and operative in accordance with a preferred embodiment of the present invention;

FIG. 12 is a simplified pictorial illustration of a screen display of a “Add Note” interface, accessed through the menus 210 at the top of the screen display in FIG. 2, constructed and operative in accordance with a preferred embodiment of the present invention;

FIG. 13 is a simplified pictorial illustration of a screen display of an “archive” interface, accessed through the menus 210 at the top of the screen display in FIG. 2, constructed and operative in accordance with a preferred embodiment of the present invention;

FIG. 14 is a simplified pictorial illustration of a screen display of a “scheduled archive” interface, accessed through the menus 210 at the top of the screen display in FIG. 2, constructed and operative in accordance with a preferred embodiment of the present invention;

FIG. 15 is a simplified pictorial illustration of a screen display of an “import folder” interface, accessed by pressing the “import” button in the screen display of FIG. 1, constructed and operative in accordance with a preferred embodiment of the present invention;

FIG. 16 is a simplified pictorial illustration of a screen display of an “search for folder to import” interface, accessed by pressing the “search” button in the screen display of FIG. 1, constructed and operative in accordance with a preferred embodiment of the present invention;

FIG. 17 is a simplified pictorial illustration of a screen display of an “import information source” interface, accessed by pressing the “import” button in the screen display of FIG. 3, constructed and operative in accordance with a preferred embodiment of the present invention;

FIG. 18 is a simplified pictorial illustration of a screen display of an “search for information source to import” interface, accessed by pressing the “search” button in the screen display of FIG. 3, constructed and operative in accordance with a preferred embodiment of the present invention;

FIG. 19 is a simplified pictorial illustration of a screen display of a typical web page that contains multiple elements, and that serves as an example of identifying elements within information sources by the use of element level access (ELA), in accordance with a preferred embodiment of the present invention;

FIG. 20 is a simplified flowchart of a preferred method for implementing the ELA interface, in which arrows indicate a typical order of operations, accessed through the menus 210 at the top of the screen display in FIG. 2, constructed and operative in accordance with a preferred embodiment of the present invention;

FIG. 21 is a simplified functional block diagram of a client-server implementation of an information management system constructed and operative in accordance with a preferred embodiment of the present invention;

FIG. 22 is a simplified functional block diagram of a preferred implementation of the server 2110 of FIG. 21;

FIG. 23 is a simplified functional block diagram of a preferred implementation for the portfolio service block 2220 of FIG. 22;

FIG. 24 is a simplified flow chart of a preferred method for implementing the Content Service block 2210 of FIG. 22, in which arrows indicate a typical order of operations;

FIG. 25 is a simplified data flow diagram showing preferred data flow to the content service block 2210 of FIG. 22;

FIG. 26 is a simplified control flow diagram showing preferred control flow to the content service block 2210 of FIG. 22;

FIG. 27 is a simplified flow chart diagram showing preferred order of operations of the Content Identifier block 2570 of FIG. 25; and

FIG. 28 is a simplified flow chart diagram showing the preferred order of operations of the Picture Renderer block 2560 of FIG. 25.

### DETAILED DESCRIPTION OF PREFERRED EMBODIMENTS

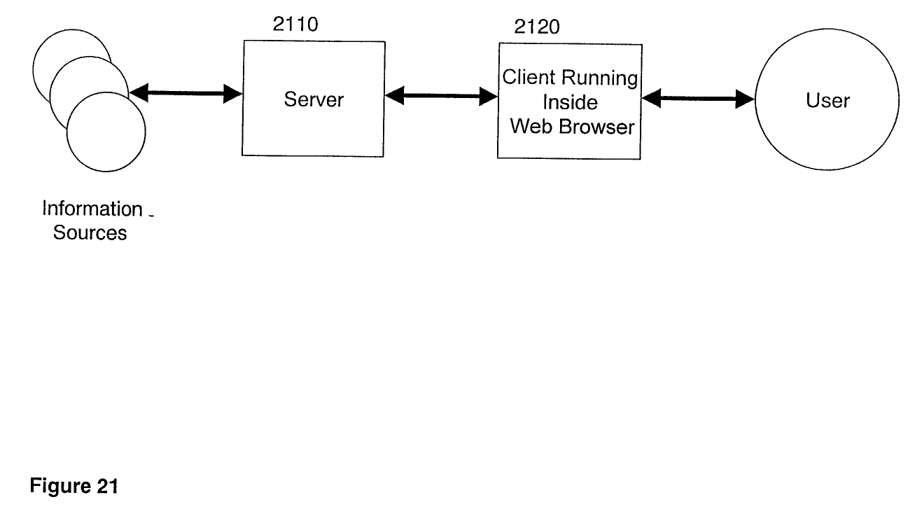

Reference is now made to FIG. 21 which is a simplified functional block diagram of an information management system constructed and operative in accordance with a preferred embodiment of the present invention. Typically, information is stored by the system using a hierarchical structure. Portfolios (one per user) contain folders (zero or more per portfolio), which in turn contain information sources (zero or more per folder). Information sources are displayed by means of topic windows, which appear in the Folder View display described below.

The system of the present invention preferably processes and/or displays information in information units termed portfolios, folders and information sources. Each of these terms is now described in detail.

Portfolios

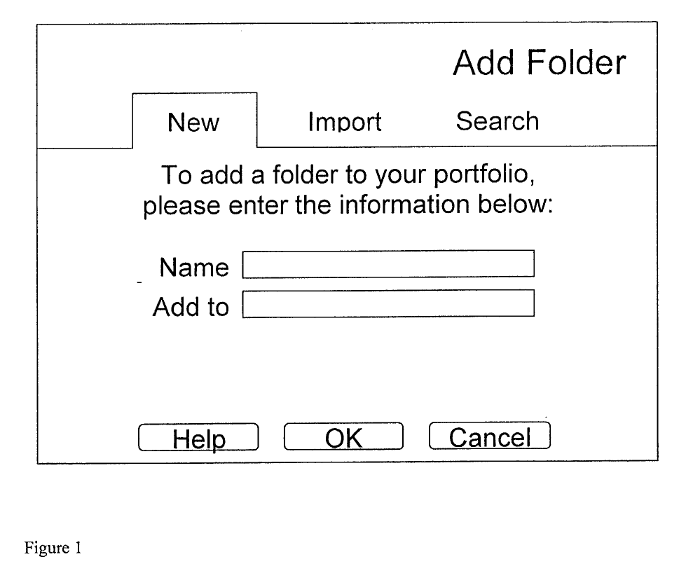

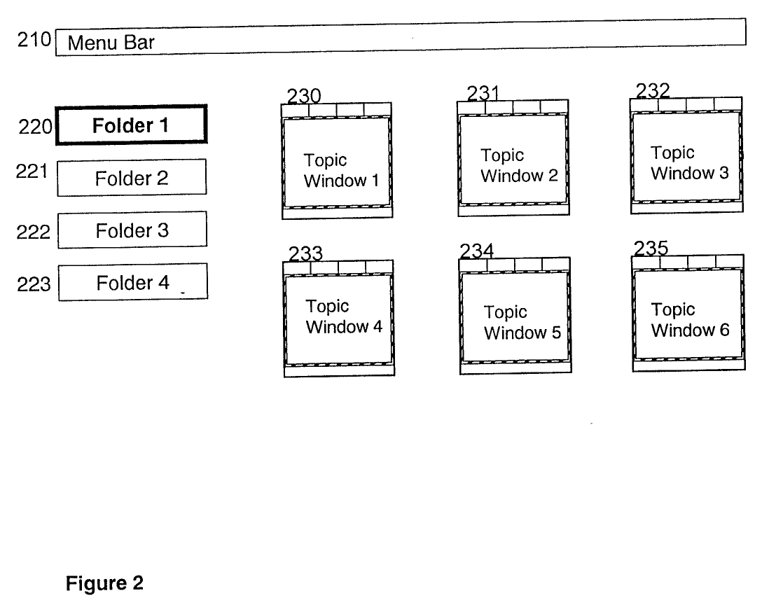

Each user of the system is assigned a portfolio. A portfolio stores the information of a particular user. Using a graphical user interface (such as FIG. 1), the user may add or remove folders from the user's portfolio. FIG. 2 shows a portfolio containing four folders, as viewed in the Folder View (explained below).

Folders

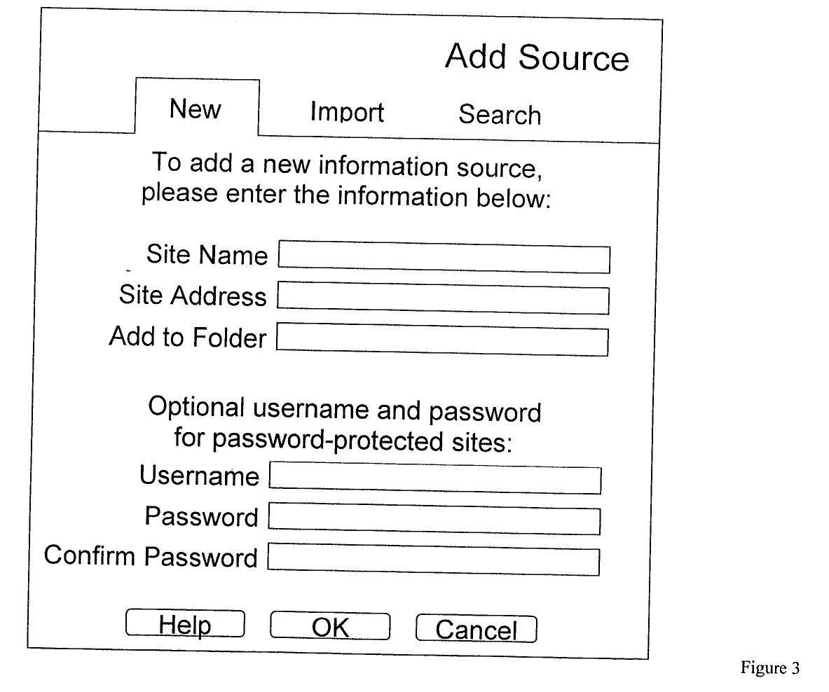

Folders contain groups of related information sources, each represented by a topic window. Folders may contain other folders and/or information sources. Using a graphical user interface, (such as FIG. 3) the user may specify one or more information sources or folders to add or remove from a folder. Each information source in a folder is represented by a topic window, defined below.

Information Sources

An information source may comprise any electronically stored information that is accessible by the system. Examples of information sources include, but are not limited to: Web documents located on the Internet or a local Intranet, files uploaded to the system or available to the system via a network file system, archives, notes stored in the system, email folders, schedule managers, any information stream or data feed coming from a local or remote source.

Using a graphical user interface the system typically allows the user to specify an entire document as an information source, or alternatively the user may identify a specific portion or portions of a document as an information source. The process of identifying specific elements of documents as information sources is known as Element Level Access (ELA) and is described below in the section “Element Level Access”.

Using the system of the present invention, the user may access information sources whose access is controlled by security measures. For example, the system of the present invention may be constructed and operative to access information sources that require a username and password. Using a graphical user interface, the user may enter the appropriate security information (e.g. username and password) into the system. The system typically stores the security information and is then able to use it to automatically access the secure information source.

The system of the present invention typically provides one, some or all of the following functionalities:

Folder View—e.g. as in FIG. 2,

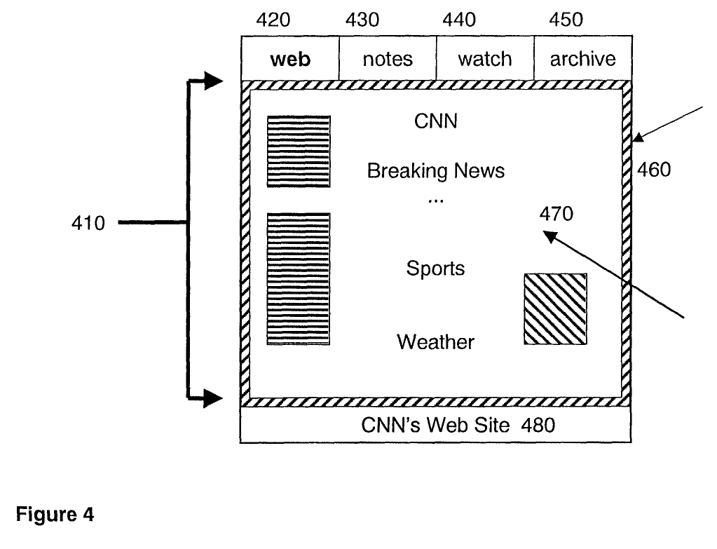

Topic Window (Modes 1, 2, 3, 4)—e.g. as in FIGS. 4, 5, 7 and 8,

Information Source Preview, Monitoring—e.g. as in FIG. 4,

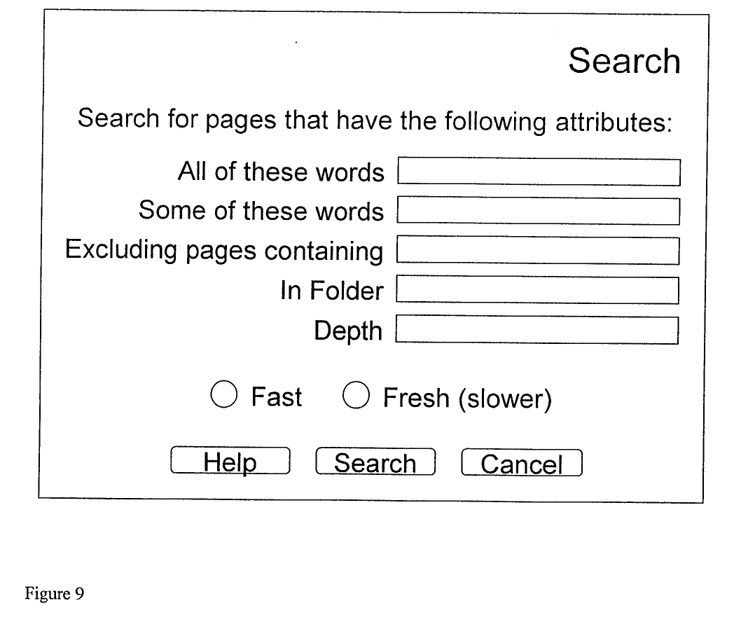

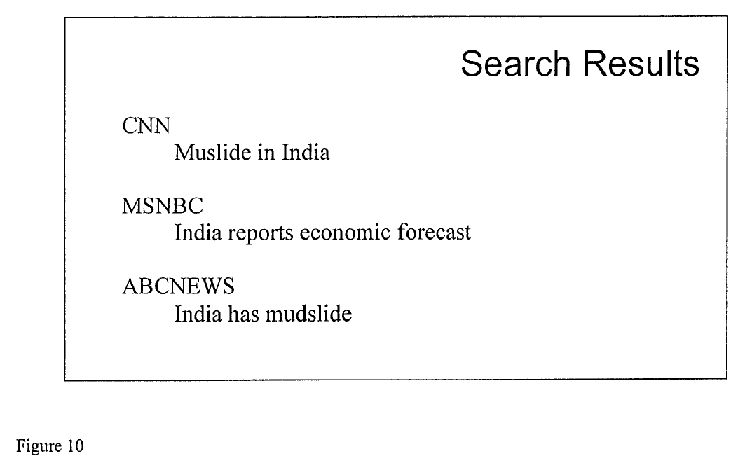

Search—e.g. as in FIGS. 9 and 10,

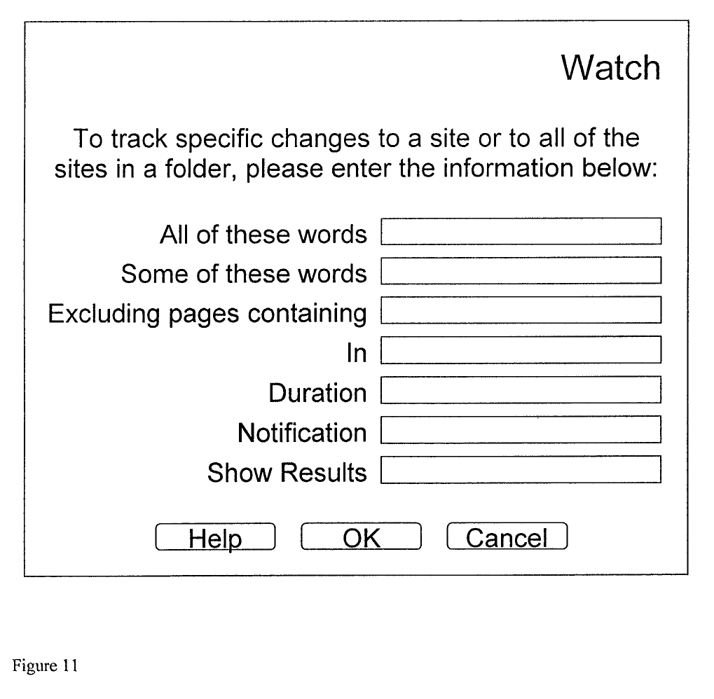

Watch—e.g. as in FIG. 11,

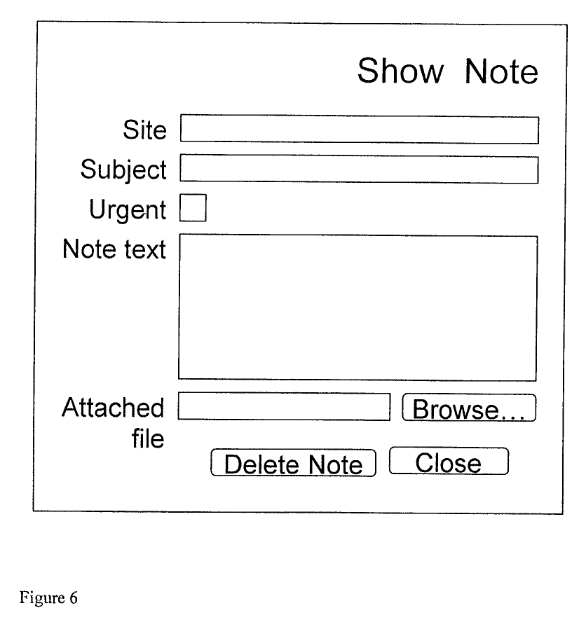

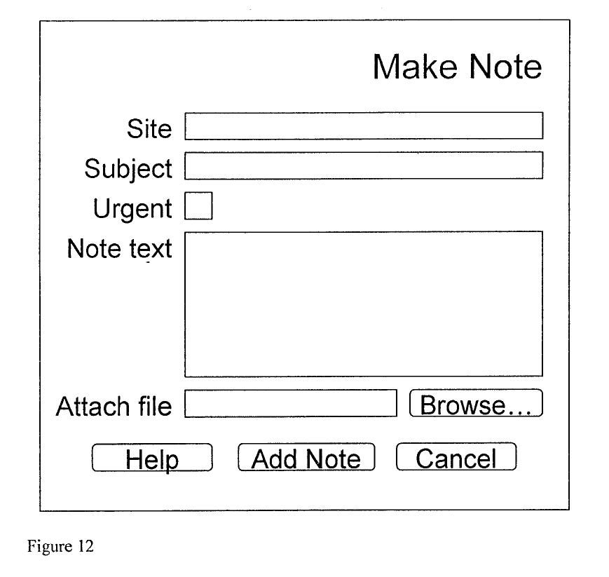

Notification, Annotation (Notes and Files)—e.g. as in FIGS. 6 and 12,

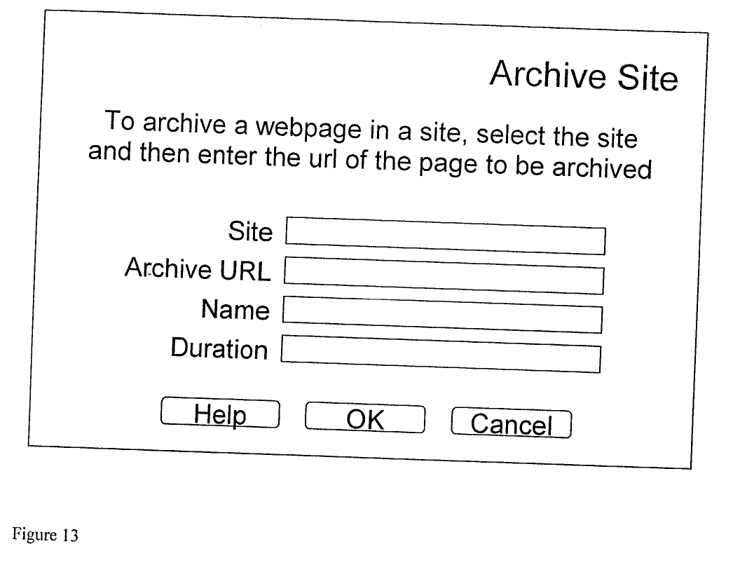

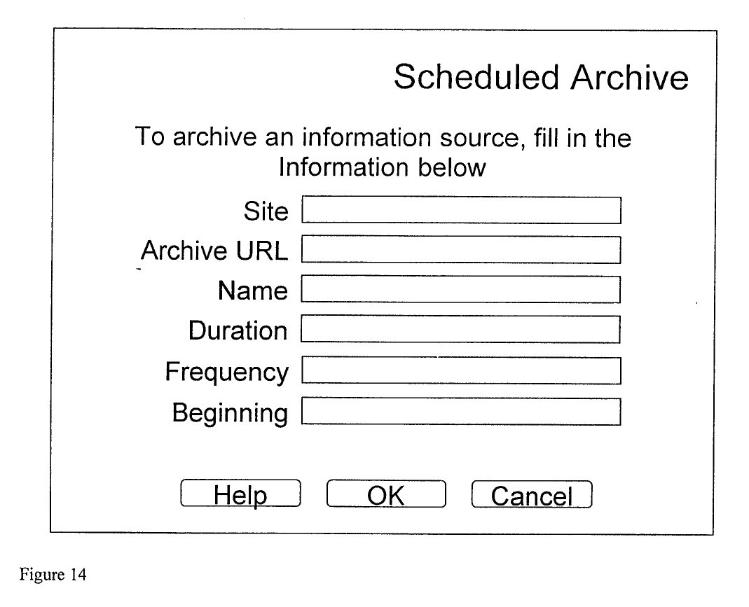

Storage: Archiving—e.g. as in FIGS. 13 and 14,

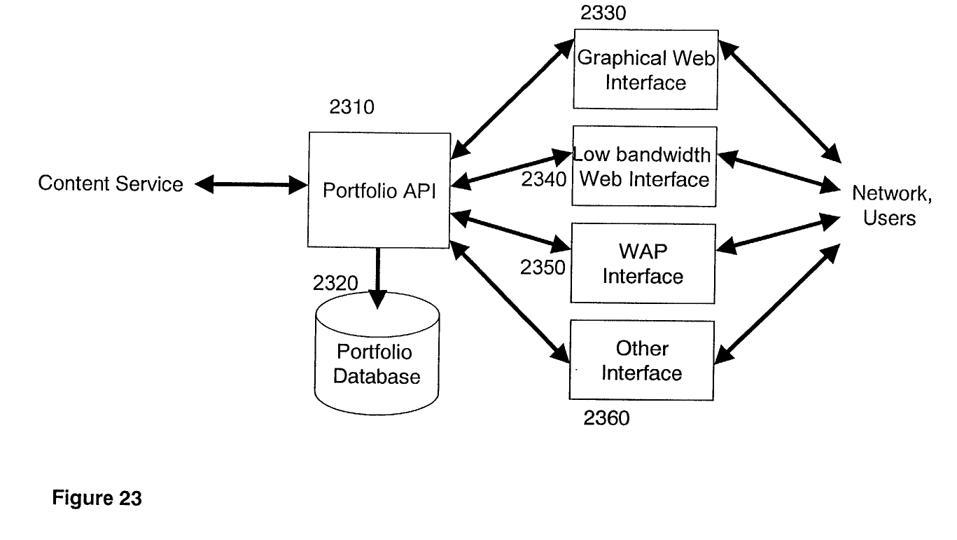

Collaboration (Groups and Sharing), Mobility/Access to system (GUI, text, WAP interfaces)—e.g. as in FIG. 23,

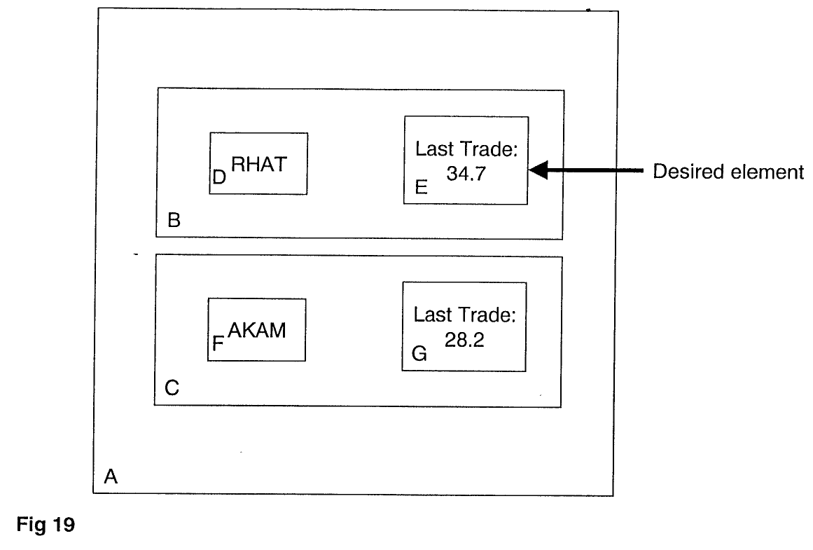

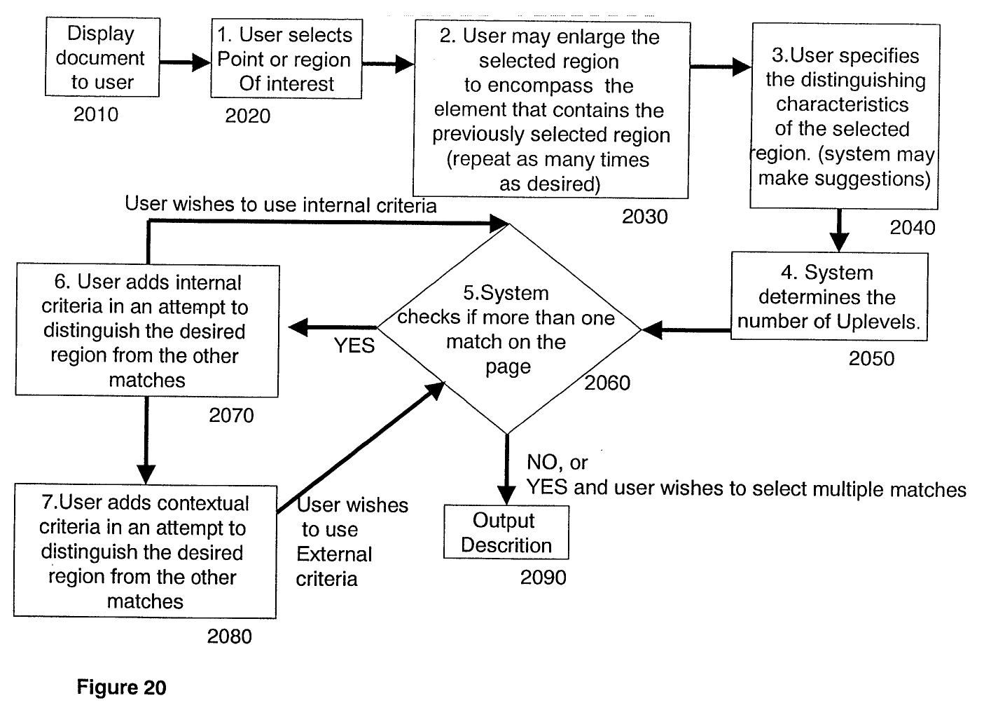

Element Level Access—e.g. as in FIGS. 19 and 20, and

Functions and Analysis.

Each of the above functionalities is now described in detail with reference to the figures designated above.

Folder View

Information available through the system typically may be viewed in a number of ways. When accessing the system with a standard web browser, information may be displayed using the Folder View (FIG. 2). In the folder view, the contents of a specific folder in a user's portfolio are displayed. Each of the information sources within the specific folder is displayed in a topic window 230, 231, 232, 233, 234, 235 described in further detail below. The topic windows are typically displayed in a grid inside the main window of the web browser being used.

Topic windows are by default displayed in mode 1, in the illustrated embodiment, resulting in a user display which as indicated by reference numerals 230-235 of FIG. 2, comprises a grid of miniature graphical renditions of the information sources in the folder. For example, if the information sources are HTML documents such as those found on the World Wide Web, they are preferably rendered by the system into a miniature version of what a user would usually see in a standard web browser. This results in the equivalent of having many small web browsers tiled across the screen, each showing an individual information source. This view provides the user with a way to view graphically multiple information sources simultaneously. Using a graphical user interface, the user may specify the arrangement of the topic windows within the folder view, including but not limited to: the size of each of the topic windows in the grid, and the number of rows or columns that are displayed. For example, a set of six topic windows in a folder may be displayed 3×2 as in FIG. 1, or 2×3 or 6×1, etc.

In the folder view, a list of folders in the user's portfolio may also be displayed in the browser window. Using a suitable graphical user interface, (such as the folder buttons 220, 221, 222, 223 of FIG. 2) the user may choose which folder's contents are to be displayed in the folder view.

In the folder view, a user may access various other functionalities of the system through a graphical user interface such as a set of menus or buttons 210 of FIG. 2) that also appear in the browser window.

Preferably, the screen display of FIG. 2 serves a main screen and the menu in FIG. 2 typically allows the user to select any of a plurality of menu options corresponding to various functionalities of the system, such as the following menu options:

Adding functionalities: Add, add information source, add folder, add note, add watch, add archive, add scheduled archive, add analysis.

Resetting functionalities: Reset (clears borders that indicate information content changes, Reset folder, Reset portfolio.

Other functionalities: Editing, Display preferences (including editing of rows and columns e.g. 3×2 or 6×1 of folder view), Search, Do Search, Groups, Edit Groups, and Edit Sharing.

Topic Windows:

As shown in FIGS. 4, 5, 7 and 8, each information source in the user's portfolio typically appears in a topic window. A schematic representation of a possible implementation of a topic window is shown in FIG. 4. Using a graphical user interface, the user may toggle a topic window between one of four modes, numbered 1, 2, 3, and 4. Buttons 420, 430, 440, 450 for toggling between modes are shown at the top of the topic window. The name of the information source is shown at the bottom of the topic window 480. The information displayed in the central area of the topic window 410 depends on the mode that the topic window is in. Four modes of each topic window provided in accordance with a preferred embodiment of the present invention are now described.

Topic Windows—Mode 1 (Web Mode):

As shown in FIG. 4, mode 1 is accessed by clicking on the “web” button 420 in a topic window (FIG. 4). In this mode, a miniaturized graphical representation of the information source is displayed in the central area 410 of the topic window. For example, if the information source is a web page, a miniaturized graphical rendition 470 of the web page is displayed in the central area 410 of the topic window. Clicking on the central area 410 of a topic window in mode 1 causes the actual information source represented by the topic window to appear in the main window of the browser, replacing the folder view (FIG. 2). This mechanism provides the user with an intuitive graphically-based method of accessing various information sources with a single click of the mouse.

As described in the “Monitoring” section below, the system typically continually monitors information sources for changes. When an information source has changed since the most recent time it was accessed by a particular user, a graphical indication (for example, a colored border 460) appears around the picture in the topic window representing that information source in the portfolio of that user. When the user clicks on the picture 470 to access the information source, the graphical indication 460 is removed.

Typically, the colored border 460 is present whenever the information source has changed since the most recent time the user has accessed the information source.

Reference numeral 470 indicates a picture of the information source shown in the central area of the Topic Window.

Topic Window—Mode 2 (Notes Mode):

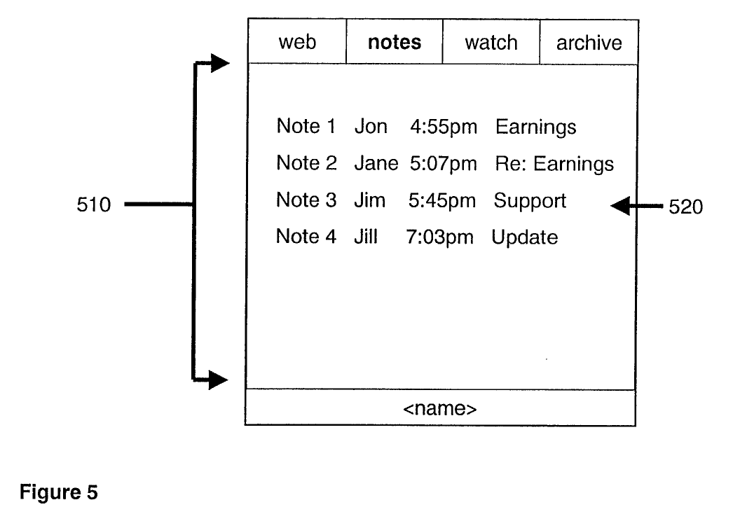

As shown in FIG. 5, the Notes Mode (Mode 2) is accessed by clicking on the “notes” button 430 in a topic window. In this mode, a list of notes assigned to the information source appears in the central area 510 of the topic window. Notes are annotations or files created by users and assigned to specific information sources, as described in the “Annotation” section below. Clicking on the row of words that refer to a specific note in the central area of the topic window of FIG. 5 causes the contents of that specific note to be displayed in a separate window (FIG. 6) on the user's screen. For example, if a user clicks on “Note 3 Jim 5:45 PM Support” 520 in FIG. 5, a separate window will appear displaying the contents of the corresponding note. Using a graphical user interface, users may delete notes from within mode 2 of a topic window.

Topic Window—Mode 3:

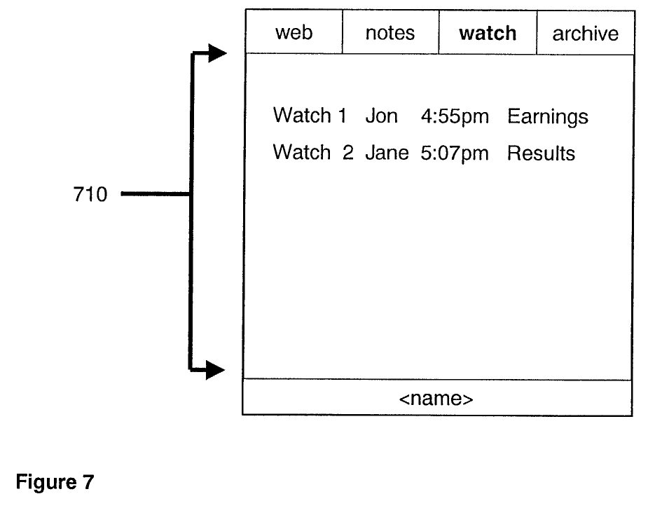

As shown in FIG. 7, the Watch Mode (Mode 3) is accessed by clicking on the “watch” button 440 in a topic window. Watches are ongoing searches that are created by users and assigned to specific information sources, as described in the “Watch” section below. In this mode, a list of watches currently assigned to the information source appears in the central area 710 of the topic window. An example of a list of 2 watches currently assigned to one information source is illustrated in FIG. 7. Using a graphical user interface, watches may also be deleted from within mode 3 of a topic window.

Topic Window—Mode 4:

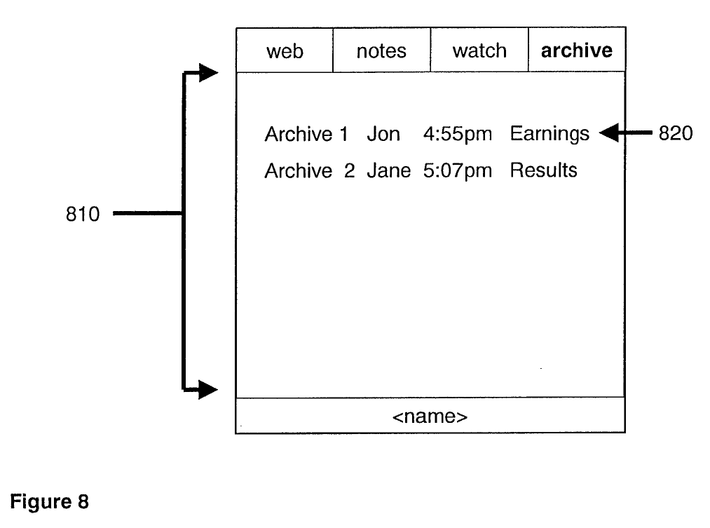

As shown in FIG. 8, the Archive Mode (Mode 4) is accessed by clicking on the “archive” button 450 in a topic window. Archives are time-stamped and annotated versions of information sources are preferably stored by the system on behalf of users and assigned to specific information sources, as described in the “archives” section below. In this mode, a list of archives assigned to the information source appears in the central area 810 of the topic window. Clicking on the row of words (Such as “Archive 1 Jon 4:55 pm Earnings” 820) that refer to a specific archive in the central area of the topic window in mode 4 causes that specific archive to be displayed in the web browser window, replacing the folder view. Using a graphical user interface, archives may also be deleted from within mode 4 of a topic window.

Information Source Preview

An information sources preview is a larger view of the graphical rendition that appears in mode 1 of the topic window. A user may use a graphical user interface to cause an information source preview to appear inside the folder view (for example, by positioning the mouse pointer over the name of the information source that appears at the bottom of the topic window). The information source preview is large enough to allow the user to read or view some or all of the information contained in the information source.

Since this graphical rendition is typically already pre-rendered on the system, the preview typically appears without having to wait for the user's machine access the information source directly. In the case of remote information sources such as documents on the World Wide Web, an information source preview typically allows the user quicker access to the information than would otherwise be achievable by accessing the information source directly through the browser. Using a graphical user interface, the user may enable or disable the information source preview functionality and modify its display properties (for example, its size).

Monitoring

The system preferably monitors information sources on an ongoing basis, and notifies users of any significant changes. On an ongoing basis, the system typically accesses all the information sources in all of the users' portfolios in order to check for modifications to the content of the information sources. The system typically detects changes by comparing the latest version of the information source content with the most recently stored version of the information source content. The system preferably notifies the users who have the information source in their portfolio of any significant changes.

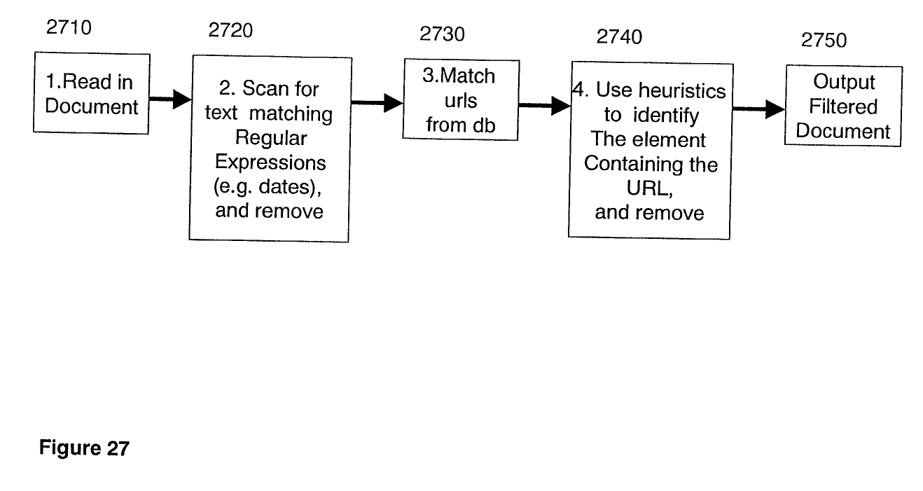

The system typically uses filters (described in the Content Identifier section below) to determine whether changes to the content are significant or insignificant. Examples of filters include but are not limited to: filters that ignore changes relating to the time and date, advertisements, or counters that report the number of visitors to a web site. See the “Content Identifier” section below. The operation of the Content Identifier 2570 is described in further detail in FIG. 27.

One method of notifying the user of a change is a colored border 460 that appears around the graphical rendition of the information source in Mode 1 of the topic window. Another method of notification is a graphical indicator that appears in the button representing the folder 220-223 that contains the information source that has changed. This latter method is useful in that it allows a user to be notified when an information source has changed somewhere in the portfolio that is outside of the folder currently being viewed in the folder view.

Change notifications are typically maintained by the system (in the Portfolio Database 2320, described below) on a per-user, per-information source basis: The system preferably keeps track of when each user accesses each specific information source. A change notification is displayed to a specific user only when a specific information source has changed more recently than that specific user has accessed that specific information source.

The system typically allows the user to clear the change notifications on an entire folder or the entire portfolio. This is useful when the user has not accessed the folder or the portfolio for an extended period of time during which many of the information sources have changed. The user may then wish to clear all the change notifications that have accumulated and only be notified of changes that occur from that point in time onwards.

Search

As shown in FIGS. 9 and 10, the system typically allows a user to identify specific information of interest through the use of the search functionality. Using a graphical user interface such as that of FIG. 9, the user may specify multiple parameters when setting up a search.

The search terms define the pattern of information to be searched for. This may include individual words, phrases, and Boolean expressions (for example “(Earnings AND Sales) OR (Year End Report) AND NOT (Quarterly)”).

The user may also specify the search domain. The search domain is the information source or set of information sources to be searched. The search domain may be selected, for example, from any group of information sources or folders within the user's portfolio.

The user may also specify the search depth, which controls how many levels the system typically branches off of an information source included in the search domain to other information sources that are not necessarily included in the search domain. For example, if a certain page on the World Wide Web is included in the search domain, a search depth of one typically directs the system to not only search the said page itself, but also to search other pages that the page refers to through hyperlinks. A search depth of two typically directs the system to further search all pages referred to by the pages referred to by the said page, and so forth.

A user may also specify the degree of search freshness. The system can typically reduce the time it takes to perform a search by searching through pre-cached, or locally stored, versions of the content instead of taking the time to access all the various information sources directly at the time of the search. This pre-cached information is typically stored by the system on a regular basis in the content database (described below), in order to perform the update checking functionality. However, the stored versions of the content may not be completely up to date with the content in the live information sources themselves. Since information sources may constantly be changing, it may be desirable for users to ensure that the system is searching recent, up-to-date versions of the information source contents. By letting the user dictate whether stored or live versions of the content are to be used, the system typically allows a user direct control over the tradeoff between the freshness of content being searched, and the speed with which the search is being performed.

The user may also specify the results format, including the level of detail in which the search results are displayed. For example, the user typically may direct the system to display only the names of the information sources that contain results matching the search terms. (For example, when searching for information about “India” within a folder containing ten news web sites, only three may match: “CNN, MSNBC and ABCNEWS report matches to the search”). Alternatively, the user may direct the system to display actual selections from the matching content in addition to the name of the information sources that contained the matching content. (For example: “CNN: Mudslide in India, MSNBC: India reports economic forecast, ABCNEWS: India has mudslide”).

When the search is complete, the results are displayed in a separate window (the “results listing window”) (FIG. 10). that appears above the main browser window. By clicking on the individual result listings in the results listings window, the corresponding information sources are displayed in the main browser window. This allows the user to view simultaneously the listing of results as well as the results themselves. This functionality provides the user with an added level of convenience over the commonly implemented interface in which either the results or the listings may be viewed, but not both at the same time.

After a search is complete, the user is given the option of automatically converting a search into a watch, described below. This saves the user the time of re-entering the information to set up a similar watch.

Watch

As shown in FIG. 11, a user may configure the system to perform a watch. A watch is an ongoing search for information matching a specific pattern, performed over a specific period of time. When setting up a watch, users can specify all the same parameters as when setting up a search, as described above in the section “search”. In addition, using a graphical user interface, the user can specify the duration of the watch, and the notification method (FIG. 11). The duration may be specified as any length of time, at the end of which the watch is completed and no more searching takes place. During the course of the watch, the content is checked at regular intervals, according the configuration of the system as described in the “Content Retriever” section below. The notification methodology may be selected from one of the notification methods available to the system, as described below in the “Notification” section.

For example, a user may want to find out whether or not a set of companies (whose web sites are contained in a folder called “Companies”) are reporting their corporate earnings during the course of a particular week. The user may set up a week-long watch for the words “Earnings” within the folder “Companies”. As the week progresses, the system preferably continually checks the various information sources within this folder, and notifies the user using the desired notification method (for example, fax) if and when the word “Earnings” appears in any of the sources.

Notification

To allow users maximum access to the system from wherever the user may be, any device with which the system can communicate preferably may be used for notifying the user. Examples include, but are not limited to, on-screen notification (such as a colored border or other graphical indication within, for example, mode 3 of the topic window), notification through an e-mail message to an email address or addresses that are pre-specified by the user, notification-through an Instant Messaging protocol, notification through a commonly available paging device, notification using a messaging system (such as SMS) to a mobile phone or mobile device, notification to a fax machine at a telephone number pre-specified by the user, notification to a printer pre-specified by the user.

Using a graphical user interface, the user may enter into the system any information the system may use to communicate with the various devices on which the user wants to receive notifications. Examples include but are not limited to: Email addresses, telephone numbers, etc.

Annotation: Notes and Files

As shown in FIGS. 6 and 12, the system preferably allows users to annotate information sources in various ways. Notes (allow a user to assign a text message to an information source or group of information sources. Using a graphical user interface (FIG. 12), a user may specify a subject or title for the note, indicate the status of the note (for example, “urgent” or “please reply”), compose the body of the note (typically a textual message) and indicate to which information source or sources in the user's portfolio the note should be assigned.

A user may also use the system to upload any type of file accessible from the user's machine and assign it to an information source or group of information sources. Notes and files assigned to an information source are typically stored on the server 2110 of the system (see the “Architecture” section below) and may be viewed through mode 2 of the topic window representing that information source. Using the collaboration and sharing capabilities of the system, described below in the “Collaboration” section, users may share notes and files with other users or groups of users.

Storage

As shown in FIGS. 13 and 14, the system also typically provides integrated storage capabilities for information sources. Using a graphical user interface (FIG. 3), a user may direct the system to archive a particular information source or set of information sources. A system typically creates an archive of an information source by locally storing in the content database a time-stamped copy of the current version of the information source contents. A user may indicate which specific information source to archive, the period of time for which the archive should be kept on the system before being deleted, and a name to assign to a particular archive. Archives are stored in the content database (see the “Architecture” section below) and may be accessed through the Archive Mode (Mode 4) of the topic window representing the particular information source. Archives are useful for users who may, in the future, wish to access content which is no longer available on the information source which provided that content originally.

The system may also be configured for scheduled archiving, in which a user indicates, using a graphical user interface, (FIG. 14) a specific point in time, or specific points in time, during which an information source should be archived by the system. The user may also indicate an archiving frequency to direct the system to archive an information source or sources at regular intervals. A user may also specify a set of conditions (see the “Functions” section below) that, if matched, will trigger the archive to be created. With scheduled archiving, the user preferably does not have to be present at the time of archiving to direct the system to create the archive.

Collaboration

The system typically provides integrated collaboration capabilities. Using a graphical user interface, users may create groups. Groups may include users and/or other groups. Groups may represent a set of users that may have certain interests in common. Groups are useful when combined with the sharing functionalities of the system.

The system typically provides integrated sharing functionalities. Using a graphical user interface, a user adding a resource (a resource is an information source or a folder containing information sources) to the system has the ability to control which other users or groups have access to the resource, as well as what type of access each user or group has (“access level”). For example, a group of users may be configured to only be able to read a resource, but not change it. Other examples of access levels include, but are not limited to: full permissions, add permissions, delete permissions, annotate permissions, read-only permissions, no permissions.

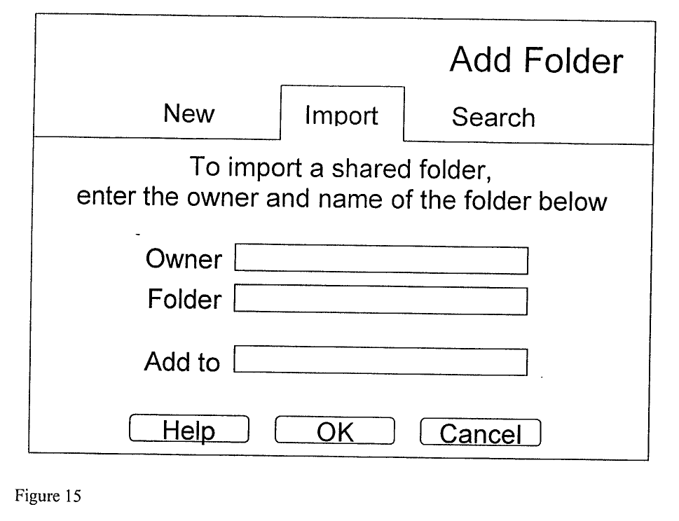

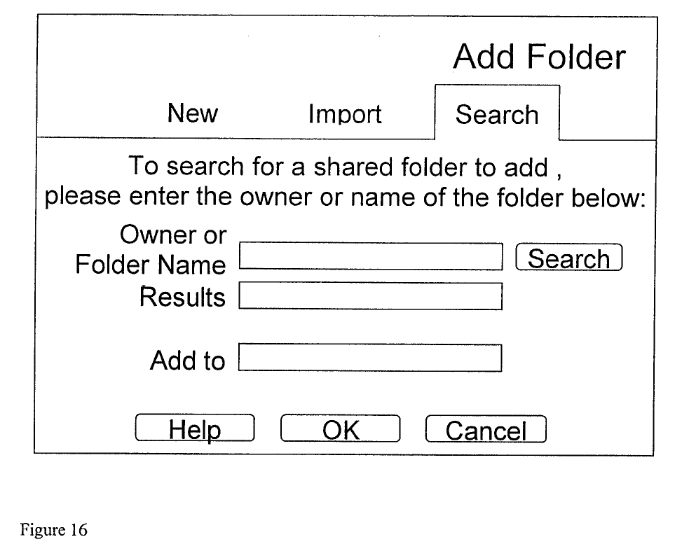

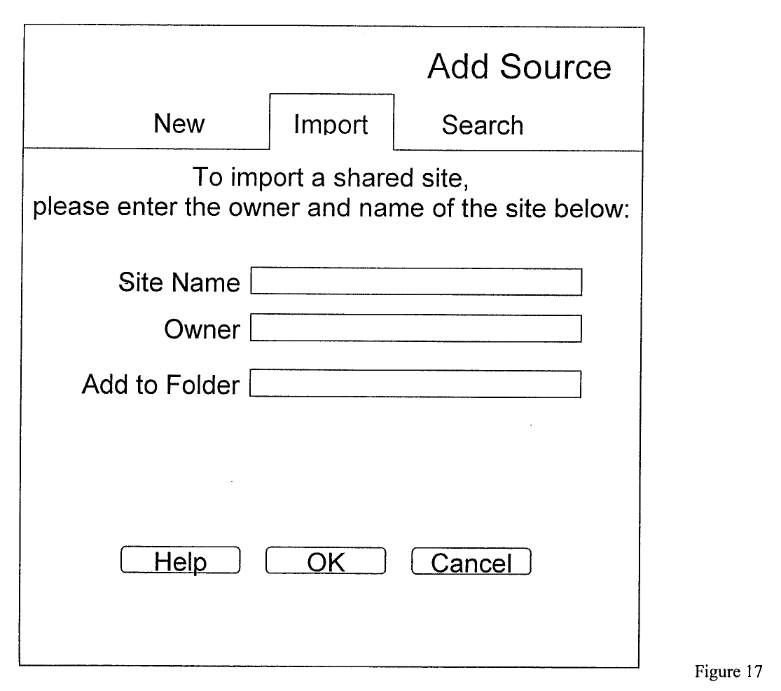

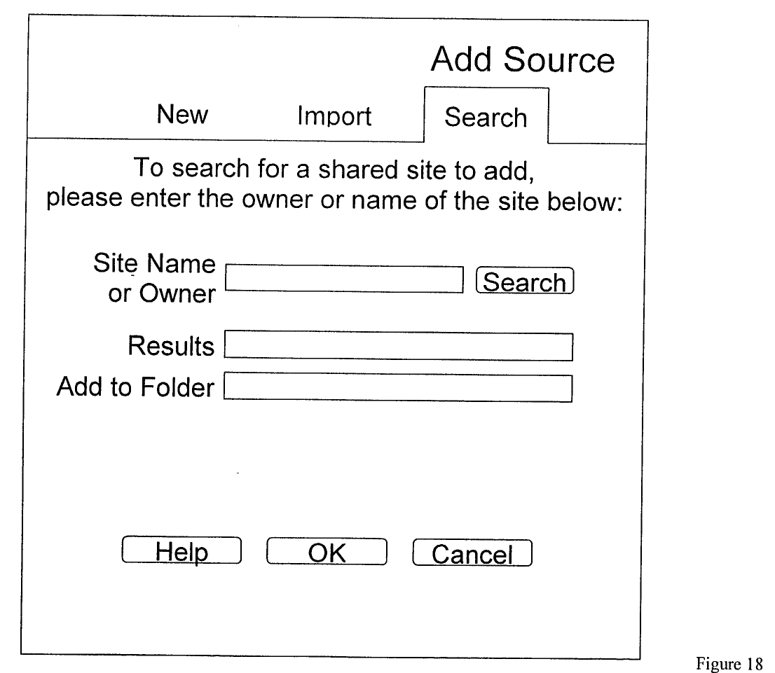

Using a graphical user interface, a user wanting to access a shared resource may import the shared resource into the user's own portfolio (FIGS. 15 and 17). If the user is unsure of the name of the resource or of the name of the user that created the resource, the user may search for the resource to import using a graphical user interface (FIGS. 16 and 18). An imported resource is added to the user's portfolio and the user may interact with it in a way that is determined by the access level set for that user for that resource.

Using the sharing functionality, groups of users can share resources. Some useful examples of sharing include, but are not limited to: Shared folders where one user assembles a set of relevant information sources and other users benefit from the useful collection of information sources; Shared notes where users can conduct a discussion relating to a particular information source or set of information sources; shared notifications where one user sets up a watch and other users benefit from the notification resulting from the watch.

Mobility/Access to the System

The system typically provides users access to the system from anywhere on any device. The primary method of interacting with the system is typically the graphical user interface 2330 of FIG. 23, accessible through a standard Web Browser and described in the sections above. To access the system in this manner, the user typically employs a computer with commonly available standard web browser software installed and a connection to a network through which the server of the system is accessible. There is no need for a user to download or install any additional software on the local machine, allowing the user a high degree of mobility relative to systems where specific software (other than a standard web browser) needs to be installed on the local machine in order to access the functionalities of the system.

The system may also be accessed through a text interface 2340. In this interface, all the graphical user interface components of the system (such as those mentioned in the descriptions above) may be replaced by equivalent text-only interfaces. This interface is useful for users accessing the system over a low bandwidth connection that would otherwise involve slower interaction times (between the user and the system) if using the standard graphical user interface. The slower interaction times would be due in large part to the time it would take to download the graphical interface components from the server to the user's computer.

The system also typically has the capabilities to be accessed by mobile devices, examples of which include, but are not limited to PDAs and mobile telephones. Special interface modules are designed in the system to handle the specific protocols of these devices. For example, a WAP (Wireless Applications Protocol) interface module typically allows access to the system from any WAP-enabled device 2350.

Security measures are typically provided for users accessing the system. Using a graphical user interface, the system typically prompts the user for a user name and password before allowing access to a particular portfolio. Using a graphical user interface, a user may also change the password that controls access to said user's portfolio. Users may also access the system through secure communication protocols. Examples include but are not limited to https.

Element Level Access: Interface

As shown in FIGS. 19 and 20 and as described above, the user may use a graphical user interface to identify a specific element of a document accessible by the system for use as an information source in the user's portfolio.

The user may identify specific elements within a document. Examples of elements include, but are not limited to: table; cell; row; column; image; list item; list; line; paragraph; frame; any region of text distinguishable from its surroundings by font size, style, color or other properties. The user may also select groups of two or more elements, whether or not they are contiguous in the document.

Specific elements may be described in a number of ways, including, but not limited to:

1. Contained or nearby text. Examples include, but are not limited to: The cell that contains the text “Last Trade”; The row that appears after the words “Minutes remaining”; The table that appears before the words “Summary Statistics”.

2. Markup tags surrounding the element. Examples include, but are not limited to: <font size 24> . . . </font>; <foo> . . . </foo>containing “bar”.

3. By structure. Examples include, but are not limited to: The second column of the fourth table; an image of a certain size.

4. Combinations of the above. Examples include, but are not limited to: the cell containing “Last trade” in the table containing “Stock 3”.

An example is shown in FIG. 19. Document A contains two tables B and C. Both tables contain stock quotes for the stocks RHAT and AKAM respectively. The name of the stocks are located in the cells D and F respectively. The last trade values are located in cells E and G respectively.

In the example, the user wants to track the last trade value for the stock RHAT, information stored in cell E. It is not enough for the user to specify “the cell containing the text Last Trade” because that matches both cells E and G. The user thus must specify also that the desired cell is contained in a table that also contains the text “RHAT”. This uniquely identifies Cell E.

A preferred process for identifying a user-selected part of a document is illustrated in FIG. 20. Steps 2010-2080 in FIG. 20 are now described in detail.

Step 2020: Using a pointing device, the user clicks or drags on a rendered version of the document to choose the region that is of interest to the user. The system typically graphically indicates the smallest structural element in the document that corresponds to the point or region selected by the user. The user may try clicking or dragging multiple times, until the satisfactory result is achieved. Each time, the system typically graphically indicates the element that the user has selected. In the example, the user selects cell E.

Step 2030: The user is given the option to enlarge the selected element until the user is satisfied that the selected element encompasses the region of interest to the user. In the example, the user does not need to enlarge the region.

Step 2040: The system typically asks the user to identify the important property or properties of the selected element that distinguish it from others—namely, what it is about the selected element that the user is actually interested in. Examples may include, but are not limited to: The element contains a specific string, or a markup tag, or an image of a certain size. The system may also generate and present possibilities to the user on what distinguishes the desired element from the others. In the example, the user indicates that the selected cell is special in that it contains the text “Last Trade”.

Step 2050: The system then typically determines the smallest element including the selected area which matches the criteria from step 2040. The system then typically counts how many levels “up” (“uplevels”) are necessary from that smallest element to reach the element selected in step 2030. Uplevels are defined below in the section (ELA Engine). This does not apply in the example, since there are zero uplevels.

Step 2060: The system then typically attempts to determine if the criteria assembled so far uniquely identify the element on the page. This is done by finding all elements on the page that are the same number of uplevels from other elements that match the criteria from step 2040. If there are no other matches, the criteria are considered sufficiently unique for the present time and the algorithm concludes. If there are other matches, the system indicates them graphically to the user. In the example, both cells E and G match the current description at this stage. So cell E is the desired region, but cell G is shown as another candidate match. The user still needs to distinguish between cell E and cell G.

Step 2070: The system asks the user why the desired region is different from the other matching regions, using the same kinds of criteria as in step 2040. At this stage, the user is looking only at element characteristics within the desired region. The user may choose to skip to the next step, if the user wishes all matches to be selected, or if the distinguishing characteristics are outside the selected regions. If this step isn't skipped, go back to step 2060. In the example, the distinguishing characteristics are located outside the selected region E, so the user skips this step.

Step 2080: Now, the user can specify distinguishing characteristics located in elements around but not in the desired region. Start graphically indicating the region that is “up” one level from the desired element, as well as regions that are “up” from the other matching elements. In the example, the user goes one level up from the selected cell E, to the containing Table B. However, since cell G is also a candidate, the containing Table C is also indicated.

The system asks the user what inside the graphically indicated desired region distinguishes it from the other graphically indicated matching regions. Step 2080 is repeated for the various desired regions, removing the matching regions which are not selected by the new criteria. When complete, the user can go back to step 2080 or is done. In the example, the user specifies that the containing region (Table B) around the selected element (Cell E) is distinguishable in that it contains the text “RHAT”. This criteria distinguishes Table B from Table C (which does not contain the text RHAT), and in turn, distinguishes the contained cell E from the contained cell G, and so the user stops at this point.

Functions and Analysis

The system typically provides users with the capability to perform various types of analysis on the information accessible by the system. Examples include, but are not limited to: determining whether a particular stock price is over a certain value, determining how many new press releases appear in a certain list, determining whether a stock is rated as “STRONG BUY” or “BUY”, comparing two prices and returning the higher of the two, etc.

When configuring the system for analysis, the user may specify the following parameters:

1. The information source or sources to be used as inputs in the analysis—This may be any information source accessible by the system, including any elements identified by a user, or any documents stored by the system in the content database.

2. The function to be used for the analysis. Functions are described below.

3. The timing—the analysis may be configured to occur once, or any number of times, beginning immediately or at a specified time or times, or at regular intervals. The user may also indicate when the system should access new copies of the contents of information sources.

4. The output—a function may output its results to one or more of a number of output targets. These include, but are not limited to: output to a file system (such as to the content database, described below), output to the user through one of the system's notification channels (see Notification” section above), output to another function.

Functions may be chained—a user may configure the system to first analyze information with one function, and then in turn analyze the resulting output with another function. This chaining preferably may be done indefinitely.

Functions allow users to perform multiple types of analysis on the information accessible from the system. Using a graphical user interface, a user may select from a set of functions when configuring the system to perform an analysis. Examples of the types of functions available include, but are not limited to:

1. Mathematical functions (+,−,/,*, max, min, etc.)

2. Textual functions (length, alphabetize, etc.)

3. Boolean functions (AND, OR, NOT, XOR, etc.)

4. Grouping functions (( ), etc.)

5. Search functions (grep, find, etc.)

6. Comparison functions (<,>,<>,<,==,=<,=>, etc.)

The system typically comprises an Applications Programmer Interface (API) that allows the set of functions available to the system to be extended. This way, the system may be further customized for users with specialized needs. For example, financial users may create a function that performs a linear regression on a set of values. Scientific users may create a function that performs a statistical analysis on scientific data.

A preferred implementation of a system synergistically providing all of the above functionalities is now described. Architecturally, the system is typically implemented in two main parts, the server 2110 and the client 2120 of FIG. 21. Most of the functionality is typically implemented in software running on commonly available computer hardware—such as a computer with a Pentium III processor, running a Linux operating system—hereafter referred to as the server. A user typically accesses the server over a digital communications network from any commonly available computer that has a connection to the Internet and commonly available software known as a standard Web Browser. The client typically comprises software that is downloaded from the server to the user's machine and then operates within the user's web browser. The server and the client then communicate with each other throughout the use of the system.

Client 2120 of FIG. 21 may, for example, comprise software written in the Java, JavaScript and HTML languages. The client software is typically constructed and operative for communicating with the server and for providing the user interface, which involves displaying information to the user and getting information from the user.

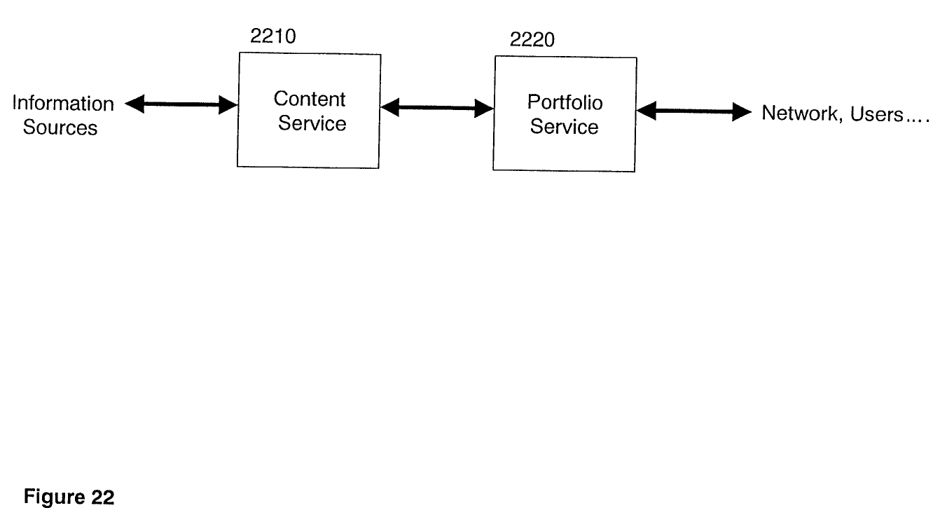

Server 2110 of FIG. 21 typically provides most of the functionality of the system. The server typically comprises the following interacting functional blocks, as shown in FIG. 22: Content Service 2210, Portfolio Service 2220. Each of the functional blocks which typically make up the server is now described in detail:

Portfolio Service 2220 of FIG. 22 is typically constructed and operative for interacting with the client 2120 (FIG. 21) (which in turn interacts with the user). The portfolio service transfers information between the client and the other components of the system. The portfolio service typically comprises the following interacting subunits, as illustrated in FIG. 23: Portfolio Database 2320, Portfolio API 2310, Portfolio Interfaces 2330, 2340, 2350, 2360. Each of the above subunits is now described in detail.

Portfolio Database 2320 of FIG. 23 typically stores all the information about specific users of the system and their portfolios, including the organized hierarchy of portfolios, folders, and information sources, as well as usernames and passwords, and information about when specific users access specific information sources.

Portfolio API 2310 of FIG. 23 typically accesses the information in the portfolio database 2320 and communicates with the content service 2210 (FIG. 21), as well as with the portfolio interfaces 2330-2360. The portfolio API allows additional customized interfaces to the system to be created.

Portfolio Interfaces 2330-2360 of FIG. 23 typically interact with the portfolio API 2310 and handle communication with the client 2120 (FIG. 21). Different portfolio interfaces interact with different clients. Examples of portfolio interfaces include, but are not limited to: the standard graphical web interface 2330, a text interface 2340, a WAP interface 2350, other customized interfaces 2360.

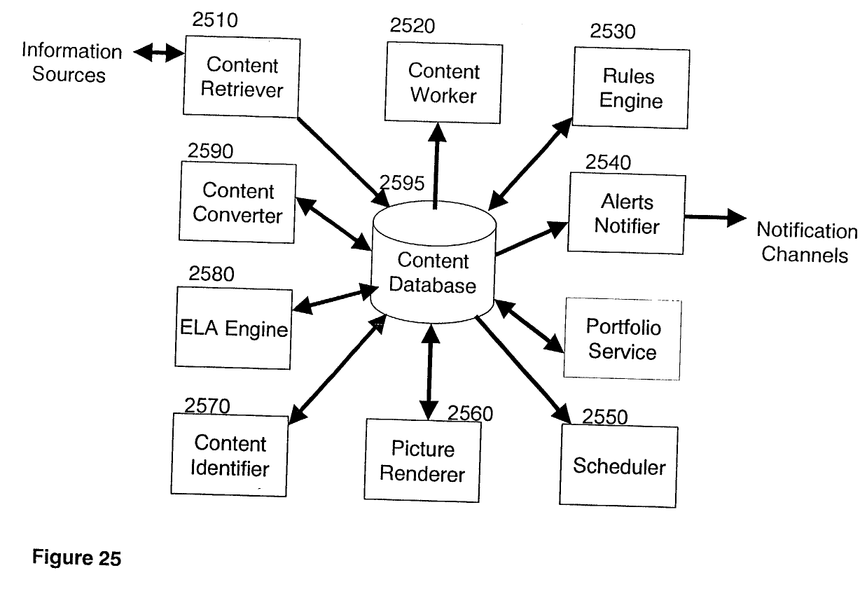

Content Service 2210 of FIG. 22 typically accesses the information sources, stores the information, and performs most of the functionalities of the system described above, typically including search, watch, update check, information access, picture rendering, functions and analysis, archiving. The content service comprises the following functional units, as shown in FIG. 25: Content Database 2595, Scheduler 2550, Rules Engine 2530, Content Worker 2520, Content Retriever 2510, Content Converter 2590, ELA engine 2580, Content Identifier 2570, Picture Renderer 2560, Alerts Notifier 2540. Each component of the system is typically implemented using a prioritized queue with multiple workers processing requests from the queue. This provides robustness (if a worker dies while processing a request, the request will be reassigned to another worker) and scalability (more workers can be added to handle greater load).

The internal control format of the system is typically a rule. Rules direct the operation of the various components of the Content Service 2210. Rules are sets of instructions that cause the various components of the Content Service 2210 to perform certain actions are specific times. Rules are stored in the Content Database 2595 and processed by the Rules Engine 2530.

The internal data format used by the content service typically comprises a document. A document typically comprises a root file and all the files that it contains (such as images and embedded documents), as well as all the files that the contained files contain recursively. A document can come from an outside source or be generated internally by the rules engine from zero or more other input documents. Each document also typically has a time stamp describing when it was retrieved by the content retriever or when it was created by the rules engine 2530. The time stamp can be used to chronologically order documents from the same source.

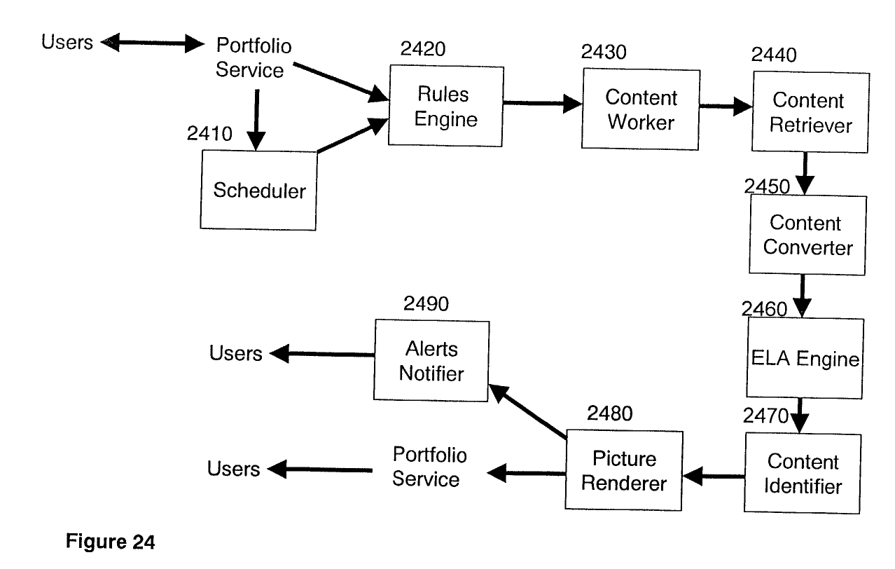

FIG. 24 is a flowchart indicating a typical order of operations of the various components of the content service 2210. For example, when performing an update check, the rules engine 2420 is triggered to begin operation by a pre-scheduled event in the scheduler 2410 (i.e. run the rule “update check” on the CNN site every two minutes”). The rules engine then directs the content worker 2430 to direct the content retriever 2440 to fetch a specific set of content (the current contents of the CNN site). The content converter 2450 then typically converts the retrieved information into the internal format used by the system. The ELA engine 2460 then uses any relevant ELA descriptions to identify specific parts of the content. The content identifier 2470 removes certain insignificant content, such as advertisements and dates. The update check rule may then be run to determine if any new information is present. The content is then rendered into a picture by the picture renderer 2480. The alerts notifier 2490 communicates relevant information to the user through one of the notification channels available to the system.

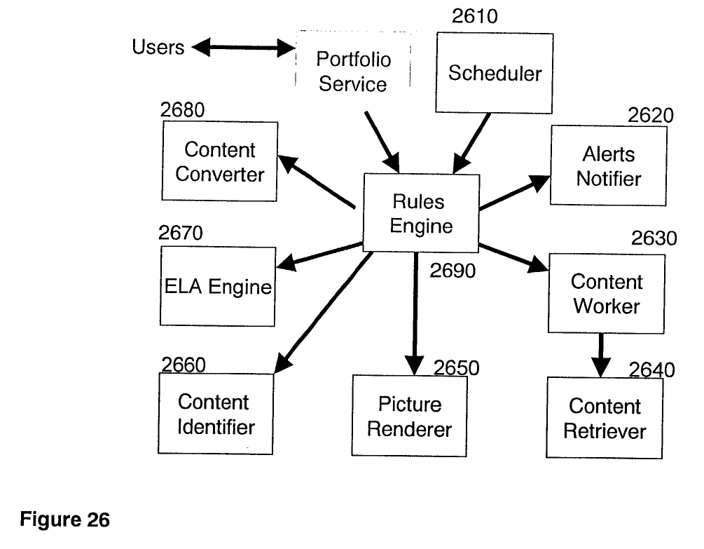

The various functional units of the content service are now described in detail with reference to FIGS. 24, 25 and 26:

Content Database 2595 of FIG. 25 typically stores all documents and rules maintained in the system, as well as scheduling information concerning when specific rules should be run and how. (For example, the “check if the current stock price is below 30” rule is scheduled to run every 15 minutes.) This scheduling information originates from the user and is stored in the content database 2595 by the portfolio service 2220.

Scheduler 2550 of FIG. 25 typically reads scheduling information from the content database 2595 and invokes rules to be run in a pre-specified fashion at pre-specified times, intervals, or conditions.

Rules engine 2530 of FIG. 25 typically directs the operation of the other components within the content service 2210. The operation of the system is therefore customizable by modifying the rules. The rules engine 2530 has a scripting language interpreter with a set of built-in rules, as well as an application programmer interface (API) for adding further customized rules. There is also a mechanism for the rules engine to communicate with the other components of the system.

Content Worker 2520 of FIG. 25 is typically constructed and operative for driving the operation of the 2510 content retriever, which in turn gets all the files related to a single document. The content worker 2520 recursively parses through a document stored in the content database 2595 to get a list of contained files, and directs the content retriever 2510 to get all the files from the appropriate information source.

Content Retriever 2510 of FIG. 25 typically gets a single file at a time from an external source, as directed by the content worker 2520. It implements caching to reduce bandwidth consumption. It deals with automatically logging in to sites that require a username and password.

Information sources are preferably checked by the content retriever 2510 if they are included in one or more user portfolios. This is useful in that it provides a high level of monitoring service to individual users while at the same time optimizing the bandwidth load for the organization as a whole. i.e. Instead of many users all individually accessing a certain information source, the system polls the information source once and notifies each of the users of the relevant information. This can reduce the bandwidth load for the organization as a whole.

The frequency of checking an information source may be determined according to a number of relevant factors, including but not limited to:

1. User-specified priorities for monitoring the information source.

2. Presence of the information source in multiple user portfolios

3. Information source response times

4. Information source update frequencies

A particular feature of the content retriever, according to a preferred embodiment of the present invention, is that it optimizes use of bandwidth for maintaining relatively up-to-date versions of multiple information sources for use by multiple users, according to the content retriever factors shown and described herein.

Content Converter 2590 of FIG. 25 typically converts the files received in various formats into one common internal format (for example, XML), so that the other parts of the system may use them. The content converter 2590 has various modules for dealing with different file formats. Examples include, but are not limited to, MSWORD, PDF, etc.

Content Identifier 2570 of FIG. 25 typically identifies (and optionally removes) specific portions of a document, such as ads and dates, according to pre-specified or user-entered identification filters in the system. The content identifier may be used to distinguish between significant and non-significant changes to content when performing monitoring, as described in the monitoring section above.

Preferred operation of the content identifier is described in FIG. 27 and typically comprises the following steps:

Step 2710: The content identifier reads in a document from the content database.

Step 2720: The content identifier uses a set of stored “regular expressions” (stored in an identifier database) to check for any dates in the document and optionally removes the matching text.

Step 2730: The content identifier uses a set of stored URLs (stored in an identifier database) to check for any advertisements in the document. The URLs are those of common commercial advertisement providers.

Step 2740: The content identifier removes the structural element surrounding the matched advertisement URL in the document. This removes the advertisement itself.

Step 2750: The content identifier outputs the filtered document to the content database 2595.

ELA (Element Level Access) Engine 2580 of FIG. 25 is typically constructed and operative for parsing a document received from an information source and extracting the specific portion that a user has described using the ELA interface described in FIG. 20. The ELA engine 2580 relies on an element description created by the user using the ELA interface (FIG. 20) to extract the appropriate information, which it then puts into a new document.

An ELA description is a piece of text that describes a specific part of an HTML document. The goal is to describe as generally as possible the specific part (element) of a document, so that that element can be used for monitoring, searching, matching, display, notification, or other purposes within the system. An ELA description may include contextual cues that may be used to help further describe the desired part of the document.

An HTML document can be described as a tree-like structure of different elements. HTML elements used by the ELA system include, but are not limited to: image, phrase, table, sub-table, line, caption, cell, row, column, item, list, paragraph, and frame. The structure is mostly a tree. The root element is a frame, and each element may contain one or more other elements of varying types. For example, a cell may contain paragraphs, a line may contain phrases and images, and a frame may contain paragraphs. It should be noted that the structure is not a proper tree because a table may be viewed as containing rows, columns, or cells, whereas the rows and columns themselves contain the same cells, each of which is in both a row, a column, and a table.

An ELA description is represented in XML and is described by an XML Schema. An example of a suitable XML schema is as follows:

```
<!-- $Id: ela.xsd,v 1.4 2001/02/28 09:16:11 marc Exp $ -->
<!-- defaults:
  minOccurs=“1” maxOccurs=“1”
  -->
<schema xmlns=“http://www.w3.org/2000/10/XMLSchema”
```

xmlns:xsi=“http://www.w3.org/2000/10/XMLSchema-instance”
xmlns:ela=“http://www.broadfire.com/xmlschemas/ela/1.0”
targetNamespace=“http://www.broadfire.com/xmlschemas/ela/1.0”>

```
<!--  noNamespaceSchemaLocation=“XMLSchema.xsd” -->
  <element name=“ela” type=“ela:elaType” />
  <!-- this is mostly for testing -->
  <element name=“elalist”>
```

<complexType>

<sequence>
<element ref=“ela:ela” maxOccurs=“unbounded” />
</sequence>

</complexType>

```
  </element>
  <complexType name=“elaType”>
```

<sequence>

<element name=“match”>

<complexType>

<choice>

<group ref=“ela:matchElement” />
<group ref=“ela:filterElement” />

</choice>

</complexType>

</element>

<element name=“uplevel” type=“nonNegativeInteger”

minOccurs=“0” />

<element name=“filter” minOccurs=“0”

maxOccurs=“unbounded”>

<complexType>

<sequence>

<element name=“context”>

<complexType>

<group ref=“ela:filterElement” />

</complexType>

</element>
<element name=“choose” minOccurs=“0”>

<complexType>

<choice>

<choice maxOccurs=“unbounded”>

<element name=“position”>

<complexType>

<simpleContent>

<extension base=“integer”>

<attribute name=“relop” type=“ela:relop” />

</extension>

</simpleContent>

</complexType>

</element>
<element name=“after”>

<complexType>

<choice>

<group ref=“ela:imageMatch” />
<group ref=“ela:textMatch” />

</choice>
<attribute name=“skip” type=“nonNegativeInteger” />
<!-- XXX this should be a positiveInteger
or “unbounded” -->
<attribute name=“count” type=“string” />
<attribute name=“range”>

<simpleType>

<restriction base=“string”>

<enumeration value=“inclusive” />
<enumeration value=“exclusive” />

</restriction>

</simpleType>

</attribute>

</complexType>

```
  </element>
  <element name=“before”>
```

<complexType>

<choice>

<group ref=“ela:imageMatch” />
<group ref=“ela:textMatch” />

</choice>
<attribute name=“skip” type=“nonNegativeInteger” />
<!-- XXX this should be a positiveInteger
or “unbounded” -->
<attribute name=“count” type=“string” />
<attribute name=“range”>

<simpleType>

<restriction base=“string”>

<enumeration value=“inclusive” />
<enumeration value=“exclusive” />

</restriction>

</simpleType>

</attribute>

</complexType>

</element>
</choice>
<element name=“triangulate”>

<complexType>

<sequence>

<element name=“row”>

<complexType>

<choice>

<group ref=“ela:imageMatch” />
<group ref=“ela:textMatch” />

</choice>

</complexType>

</element>
<element name=“column”>

<complexType>

<choice>

<group ref=“ela:imageMatch” />
<group ref=“ela:textMatch” />

</choice>

</complexType>

</element>

</sequence>

</complexType>

</element>

</choice>

</complexType>

</element>

</sequence>

</complexType>

</element>

</sequence>
</complexType>
<group name=“filterElement”>

<choice>

<!-- canonical order within a type is
<text> <image> <select>
Not all sections will appear within all types.
-->
<element name=“line”>

<complexType>

<sequence>

<group ref=“ela:textMatch” />
<group ref=“ela:imageMatch” />

</sequence>

</complexType>

```
  </element>
  <element name=“caption”>
```

<complexType>

<sequence>

<group ref=“ela:textMatch” />
<group ref=“ela:imageMatch” />

</sequence>

</complexType>

```
  </element>
  <element name=“cell”>
<complexType>
```

<sequence>

<group ref=“ela:textMatch” />
<group ref=“ela:imageMatch” />

</sequence>

</complexType>

</element>
<element name=“row”>

<complexType>

<sequence>

<group ref=“ela:textMatch” />
<group ref=“ela:imageMatch” />

</sequence>

</complexType>

</element>
<element name=“column”>

<complexType>

<sequence>

<group ref=“ela:textMatch” />
<group ref=“ela:imageMatch” />

</sequence>

</complexType>

</element>
<element name=“table”>

<complexType>

<sequence>

<group ref=“ela:textMatch” />
<group ref=“ela:imageMatch” />
<choice minOccurs=“0” maxOccurs=“unbounded”>

<element name=“rows”>

<complexType>

<simpleContent>

<extension base=“positiveInteger”>

<attribute name=“relop” type=“ela:relop” />

</extension>

</simpleContent>

</complexType>

</element>
<element name=“columns”>

<complexType>

<simpleContent>

<extension base=“positiveInteger”>

<attribute name=“relop” type=“ela:relop” />

</extension>

</simpleContent>

</complexType>

</element>

```
  </choice>
  <element name=“select” minOccurs=“0”>
```

<complexType>

<attribute name=“type”>

<simpleType>
<restriction base=“string”>

<enumeration value=“first” />
<enumeration value=“last” />
<enumeration value=“widest” />
<enumeration value“tallest” />
<enumeration value“largest” />

</restriction>

</simpleType>

</attribute>

</complexType>

</element>
</sequence>

</complexType>

```
  </element>
  <element name=“item”>
```

<complexType>

```
  <sequence>
  <group ref=“ela:textMatch” />
  <group ref=“ela:imageMatch” />
</sequence>
```

</complexType>

```
  </element>
  <element name=“list”>
```

<complexType>

<sequence>

<group ref=“ela:textMatch” />
<group ref=“ela:imageMatch” />
<element name=“items” minOccurs=“0”

maxOccurs=“unbounded”>

<complexType>

<simpleContent>

<extension base=“positiveInteger”>

<attribute name=“relop” type=“ela:relop” />

</extension>

</simpleContent>

</complexType>

```
  </element>
  <element name=“select” minOccurs=“0”>
```

<complexType>

<attribute name=“type”>
<simpleType>

<restriction base=“string”>

<enumeration value=“longest” />

</restriction>

</simpleType>
</attribute>

</complexType>

</element>
<sequence>

</complexType>

```
  </element>
  <element name=“paragraph”>
```

<complexType>
<sequence>

```
  <group ref=“ela:textMatch” />
  <group ref=“ela:imageMatch” />
```

```
  </sequence>
</complexType>
  </element>
  <element name=“frame”>
<complexType>
```

<sequence>

<group ref=“ela:textMatch” />
<group ref=“ela:imageMatch” />

</sequence>

</complexType>

</element>

</choice>

```
  </group>
  <group name=“matchElement”>
```

<choice>

<element name=“image”>

<complexType>
<sequence>

<group ref=“ela:imageMatch” />
<element name=“select” minOccurs=“0”>

<complexType>

<attribute name=“type”>

<simpleType>

<restriction base=“string”>

<enumeration value=“first” />
<enumeration value=“last” />
<enumeration value=“widest” />
<enumeration value=“tallest” />
<enumeration value=“largest” />

</restriction>

</simpleType>
</attribute>

</ complexType>

</element>

</sequence>

</complexType>

```
  </element>
  <element name=“phrase”>
```

<complexType>

<sequence>

<group ref=“ela:textMatch” />
<element name=“url” type=“string”

minOccurs=“0” maxOccurs=“unbounded” />

</sequence>

</complexType>

</element>
<element name=“subtable”>

<complexType>

<sequence>

<group ref=“ela:textMatch” />
<group ref=“ela:imageMatch” />

</sequence>
<attribute name=“left” type=“integer” />
<attribute name=“right” type=“integer” />
<attribute name=“top” type=“integer” />
<attribute name=“bottom” type=“integer” />

</complexType>

</element>
</choice>

</group>
<group name=“imageMatch”>

<sequence>

<element name=“image” minOccurs=“0”

maxOccurs=“unbounded”>

<complexType>

<choice maxOccurs=“unbounded”>

<element name=“width”>

<complexType>

<simpleContent>

<extension base=“nonNegativeInteger”>

<attribute name=“relop” type=“ela:relop” />

</extension>

</simpleContent>

</complexType>

</element>
<element name=“height”>

<complexType>

<simpleContent>

<extension base=“nonNegativeInteger”>

<attribute name=“relop” type=“ela:relop”/>

</extension>

</simpleContent>

</complexType>

</element>
<element name=“src” type=“string” />
<element name=“alt” type=“string” />

</choice>

</complexType>

</element>

</sequence>

</group>
<group name=“textMatch”>

<sequence>

<element name=“text” minOccurs=“0”

maxOccurs=“unbounded”>

<complexType>

<choice maxOccurs=“unbounded”>

<element name=“contains” type=“string” />
<element name=“face” type=“string” />
<element name=“color” type=“string” />
<element name=“font-family” type=“string” />
<element name=“size” type=“positiveInteger” />

</choice>

</complexType>

</element>

</ sequence>

```
  </group>
  <simpleType name=“relop”>
```

<restriction base=“string”>

<enumeration value=“eq” />
<enumeration value=“lt” />
<enumeration value=“gt” />
<enumeration value=“le” />
<enumeration value=“ge” />
<enumeration value=“ne” />

</restriction>

</simpleType>
</schema>

Each ELA description typically comprises one, some, or all of the following three parts:

1. The first, main part is a <match>tag that describes the desired element. This tag typically describes the element to match as precisely as possible without taking into account the context around the element, but focusing instead on the contents of the element itself. An element may be described by the type of the element and by a combination of text contained in the element, images contained in the element, characteristics of the element itself (for example, for an image, the source URL of the image).

2. The second part is an <uplevel>tag stating the number of uplevels to use when matching. An uplevel typically describes a situation where an element is contained within another element of a similar type. For example, with an uplevel of 0, a description could describe “the cell containing the words ‘Last Trade’”. With an uplevel of 1, a description could describe “the cell containing the cell containing the words ‘Last Trade’”, etc. The default uplevel is 0. The semantics of this are described in the algorithm below.

3. The third part is a list of <filter>tags. Each filter typically describes a property of the element or of its surroundings. Filters may be used in series to filter out multiple potential matches in order to ultimately identify the single desired element. Filters may be based on descriptions of the element's context, comparisons between multiple matching candidate elements, as well as the location of the element relative to other elements in the document. Three types of filters are now described: context filters, comparison filters, and location filters.

A. Context Filter—A context filter describes the desired element according to the properties of an element that contains it. For example, a match tag for “a cell that contains the text ‘Last Trade’ may be used in conjunction with the filter “contained in a table that has the text ‘RHAT’”. (see example below)

B. Comparison filter—A comparison filter is based on a comparison between multiple matching candidates. For example, a match tag for “any image” may be used in conjunction with the filter “the largest of all the images”. Comparison filters include, but are not limited to: largest, smallest, tallest, widest, first, last.

C. Location filters—Location filters may be used to identify a desired element or group of elements (“the desired element”) from within a set of elements that are contained in a larger element (“the context”) Location filters include, but are not limited to position location filters and before-and-after-location filters, each of which is described below.

Position Location Filters:

The position filter may be used to identify a desired element within a context, according to the position of the desired element within the set of elements that are contained in the context. Examples include, but are not limited to: In a context containing ten cells, “the 3rd cell”, “the first two cells”, “the third through fifth cells” “the second through third-from-last cells”, “the last four cells”, etc.

Before and After Location Filters:

The desired element is identified by its position relative to another, more easy-to-identify element (“the anchor”) also located in the context. EXAMPLE: the context is a column of cells. The desired element is a particular cell within the context that contains constantly changing text (e.g. breaking news stories) and is therefore difficult to describe according to the text that it contains. The anchor is a cell immediately preceding the desired element that always contains the text “Today's Breaking News”. An “after” filter may be used to create the description “the cell that is one element after the cell that contains the text ‘Today's Breaking News’”. Before and After filters may specify an anchor description, a skip distance (e.g. “beginning one after the anchor, two after, etc.”), and a spanning length (how many elements to include, e.g “select the three cells that begin one after the cell containing the text “Today's Breaking News”). Before and After filters may be used in conjunction with one another to describe a specific range of cells.

An example of an ELA description is found below. The example describes the desired cell pictured in FIG. 19. The HTML document includes a set of tables containing various stock quotes. The user is interested in the “Last Trade” price of the stock “RHAT”. The user thus indicates that the desired element is “the cell containing the text ‘Last Trade’”. However, since there are multiple stocks reported in this document, a context filter uses the context of the containing table to describe the desired element. The full description thus reads: “the cell containing the text ‘Last Trade’ in the table that contains the text ‘RHAT’”

Here is an example of an ELA description:

<ela:ela>

<match>

<cell>

<text><contains>Last Trade</contains></text>

</cell>

```
  </match>
  <uplevel>0</uplevel> <!-- default, may be omitted -->
  <filter>
```

<context>

<table>

<text><contains>RHAT</contains></text>

</table>

</context>

</filter>

</ela:ela>

The first part is a <match>tag that describes a cell. The cell described is any which contains the text “Last Trade”. The next part is the uplevel, which is 0. The third part is a <filter>tag that describes a single containing element. The containing element is a table, which contains the text “RHAT”. Given an HTML document and an ELA description, a process by which the system may identify the desired element is now described. Definitions and variables pertaining to a preferred process are first described, followed by a description of the steps a-e which the process preferably comprises.

Definitions:

A “minimal set” of matches is one in which no element contains another element in the non-minimal set. This avoids ambiguities in certain cases.

The term “tag” does not have its usual XML definition, but is instead used below to describe an element in the XML ELA description.

An element “matches” a tag if it is of the type specified, and contains the text and/or images described.

An element A is “immediately contained” in an element B if there is no element C such that C is a descendant in the tree-like structure of B, and A is a descendant of C.

Variables:

n is the number of elements which match in step a.

k is used to iterate over n.

f is the number of filter tags.

i is used to iterate over f.

Steps:

a. Generate a minimal set of all elements {M_{—}1 . . . M₁₃n} which match the <match>tag. This generates the first list of matches.

b. Generate a set of all elements {R_{—}1 . . . R_n}such that each R_k is up “u” levels from M_k, as specified by the <uplevel>tag, and has the same type as M_k. (If u==0, this is just an identity mapping.) This generates the candidate elements containing the initial matches in step a.

c. Construct a set of elements {C_{—}0_{—}1 . . . C_{—}0_n}, identical to

R. This is typically done for convenience.

d. For each filter tag i (from 1 to f), perform (i), (ii), (iii) and (iv), described below. In other words, step d is repeated multiple times, each time using another filter from the ELA description.

(i) For each element C_(i-1)_k, choose an element C_i_k where C_i_k matches the <context>tag of the <filter>tag and contains C_(i-1)_k. If no such element exists, there will be no element C_i_k. This step generates a new set of candidates that include an additional level of context around the preceding set of candidates AND that match the desired properties of the filter.

(ii) Make C_i a minimal set by removing elements that contain other elements in the set. This is done to avoid ambiguities and is related to the definition of “minimal set” above.

iii) If the <context>tag contains a <select>tag, remove all elements from C_i except the selected element. This step ends the algorithm if used. This step implements comparison filters. It allows another way of identifying one of the candidates by comparing the candidates to each other. For example, give me the biggest table, or tallest image.

(iv) If the <filter>tag contains a <choose>tag, then generate a set {S_{—}1 . . . S_n} where S_k is the element immediately contained in C_i_k which contains C_(i-1)_k. Assign colors to each element S_k such that S_k1 has the same color as S_k2 if and only if C_i_k1 is the same element as C_i_k2. Then, for each element S_k, determine if it matches the <choose>tag. If it does, then mark all elements of the same color in S which are before, after, or in the position described by the <choose>tag. Finally, for each element S_k′ which is not marked, remove C_i_k′. This step implements Location filters, including before, after, and position.

e. The result is the concatenation of all R_k where C_m_k exists (survived the filtering process). Depending on the type of the elements R_k, the complete result may require some extra markup, such as a <table>around cells, or <ul>/<il>/<ol> around list items. The final desired element is formatted according to the desired type.

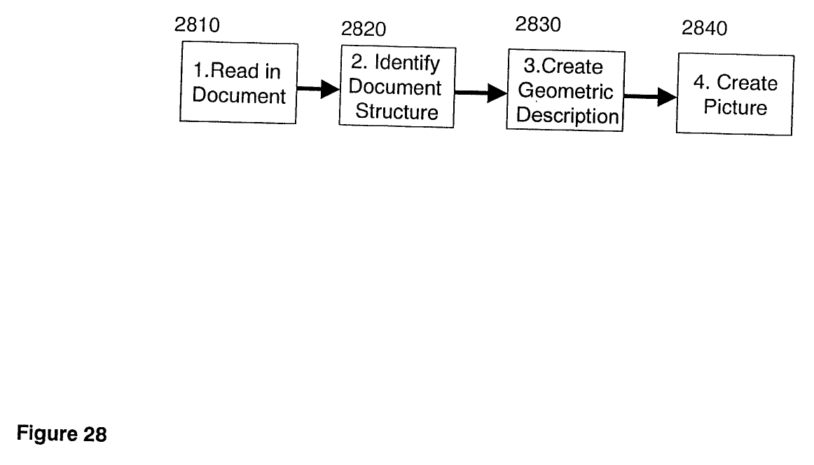

Picture Renderer 2560 of FIG. 25 creates a graphical image from a document, which may be used in the folder view part of the user interface (FIG. 2). A preferred method of operation for the Picture Renderer 2560 is described in FIG. 28 and preferably includes the following steps:

Step 2810: The picture renderer 2560 reads in a document from the content database 2595.

Step 2820: The picture renderer 2560 identifies the document structure.

Step 2830: The picture renderer 2560 creates a geometric description of a document based on the structure.

Step 2840: The picture renderer 2560 creates a picture based on the geometric description.

Alerts Notifier 2540 of FIG. 25 typically sends a document to the user, via any of a number of services. Examples include, but are not limited to email, sms, fax, and Instant Messenger.

The internal representation of an ELA description shown and described herein allows the system of the present invention to handle a high level of resolution, including cells and rows, grouping of contiguous/non-contiguous elements, flexible descriptions of elements based on a combination of multiple internal properties, and multiple relationships to other elements. A particular advantage of the preferred internal representation shown and described herein is that it allows the system to identify the desired elements consistently within a changing document, even in the face of other elements in the document that contain many similarities and/or certain modifications to the structure and content of the document.

The following example work-sessions describe how an end-user may use the system of the present invention to benefit from some of its functionalities. The user in the example is an employee at a financial services organization. The following example work-sessions are described: Portfolio creation, Accessing information, Searching and watching, Archiving, Groups and sharing, Functions and analyses.

### Example I

### Portfolio Creation Worksession

Using a graphical user interface, a user, John Doe, creates a portfolio when using the system for the first time. This involves entering the user name and password that will be required for the user to access his portfolio. The user also enters information that the system may use to communicate with the user over certain notification channels (like email, pager, fax, etc.).

The user is assigned a new, empty portfolio—one that contains no folders and no information sources. Using a graphical user interface, the user adds new folders to his portfolio. For example, the user creates a folder named “Releases”, which he intends to populate with information sources, such as websites that contain press releases of companies in which he is interested. The user also creates a Folder named “Stocks”, which he intends to populate with information sources related to the stocks in which he is interested.

Using a graphical user interface, the user then adds information sources to the folders that he has created. For example, the user adds the web sites listing the up-to-date press releases of certain corporations to the “Releases” folder. Either these sites contain solely press releases, or the user may use Elaement Level Access to specify the specific parts of the web pages that contain the press releases. The user also wishes to select a stock price from a document that contains a list of stock prices. Using the graphical user interface described above in the section “Identifying Information Sources Within Documents”, the user selects the specific stock price he is interested in from the document.

### Example II

### Accessing Information Worksession

After creating the portfolio and populating it with the information sources of interest, the user may use the system to speed his access to the information. If the user did not have the system available, the user would need to begin each work-day by using a web browser to visit each press release site individually to check for new press releases. Now, with the system, the user can simply open up the “Releases” folder that he has defined within his Folder View, and instantly view all of the information sources miniaturized, tiled across the browser window. Any information sources that have changed since the last time the user had checked them are indicated by a colored border. The user might instantly see that only three out of nine information sources have changed. This means that the user does not have to check the other six that have not changed, saving the user significant amounts of time.

To preview an information source, the user may invoke an information source preview by moving the pointing device so that the cursor is positioned over the name of the information source. The preview allows the user to see the contents of an information source (by looking at the rendered picture of a version of the content that is pre-cached on the server) without having to wait to retrieve the information source directly from its source, saving additional time. The user may access an information source directly by clicking on the pictoral representation of the information source in the topic window.

### Example III

### Searching and Watching Worksession

The user now wants to know if any of the companies in the “Releases” folder have issued a press release about their earning recently. Using a graphical user interface, a user sets up a search for the search term “Earnings” with the search domain being the “Releases” folder in his portfolio. The system performs the search and returns a list of results, listing any matching press releases. Using a standard search engine, the user would have had to indicate the various companies that the user is interested in searching. Using the present system, however, the list of companies that interest the user are already in the system in the form of the user's portfolio. After having set up the portfolio just once, all the user needs to do is specify the appropriate folder to search each time a search is to be performed. In this way, the combination of the search feature with the ability of the user to store an organized collection of information sources on the system results in added convenience for the user.

The user may then want to be notified at any time during the following week if any of the press releases appearing over that period relate to corporate earnings. The user therefore sets up a watch, similar to the previous search, with the duration set to one week. In this example, the user specifies fax notification. Sometime later that week, a new press release relating to earnings appears on one of the information sources included in the “Releases” folder. Soon thereafter, the system notices the matching press release, and communicates the results to the user on the user's fax machine.

### Example IV

### Archiving Worksession

The user wants to store the content of an information source for later reference, for example one of the press releases appearing in an information source in the “Releases” folder. Using a graphical user interface, the user archives the content of interest. At a later time, the user may access the archive through mode 4 of the topic window representing the information source. This information will then be available to the user even if it is no longer stored on the original information source.

### Example V

### Groups and Sharing Worksession

The user wants to share his information with a number of colleagues. Using a graphical user interface, the user sets up a group named “colleagues” that includes the login names of the various colleagues. The user may then share various parts of his portfolio with the “colleagues” group.

For example, the user may make his “Releases” folder available to the group. The various users in the group may then import the “Releases” folder into their own portfolios. One user in the group can then create an archive for the benefit of another—for example when another user is absent during the period of time that a specific piece of content is available on an information source. Users can also discuss developments in the press releases using notes. When a new notes is created by another user in the group, a graphical indication appears on the notes on a user's red The notes are accessible through mode 2 of the topic window representing the information source. One user can set up a watch in which other users in a group will be notified when a result matches.

### Example VI

### Functions and Analyses Worksession

The user may configure the system to perform certain analyses on the information contained in the portfolio. For example, the user may direct the system to notify him every time a stock price goes above a certain value. Alternatively, the user may direct the system to automatically archive the contents of an information source every time a press release with the words Earnings appears.

It is appreciated that the software components of the present invention may, if desired, be implemented in ROM (read-only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. An information management system comprising:
a plurality of information sources; and
an information source previewer operative to provide a preview of the information sources comprising a less than complete view of at least some of the information sources.

2. An information management system comprising:
at least one representations of information sources;
a graphical user interface integrated with at least one of the representations of the information sources; and
an archiving system operative to allow users to time-stamp and archive at least one representations of information sources.

3. A system according to claim 2 wherein said archiving system is operative to allow remote archiving.

4. A system according to claim 2 whrein said archiving system comprises an annotator.

5. A system according to claim 2 wherein said graphical user interface allows a user to specify which of a plurality of other users can access the content and how long content is to be stored.

6. An information management system comprising:
an archiving system operative to allow users to time-stamp and archive content; and
a scheduling system allowing the archiving system to operate automatically in accordance with a predetermined schedule.

7. A system according to claim 6 wherein the scheduling system operates the archiving system in accordance with at least one triggering rule.

8. A system according to claim 6 wherein the scheduling system is operative to perform a watch function in which predefined content is watched for.

9. An information management system comprising:
a content searcher;
a search-defining GUI allowing a user to define a search; and
a watch-defining GUI allowing a user to define a watch at least by automatically converting a previously defined search into a watch.

10. An information management system comprising:
a content searcher; and
a search-defining GUI allowing a user to define at least freshness of search.

11. An information management system comprising:
a content searcher; and
a search-defining GUI allowing a user to define at least depth of search.

12. An information management system comprising:
a content searcher; and
a search-defining GUI allowing a user to define at least duration of search.

13. An information management system comprising:
an information source manager including a set of user-defined information sources;
a content searcher; and
a search-defining GUI allowing a user to define a subset of the user-defined information sources to be searched.

14. An information management system comprising:
a server storing user-defined folders, and
a client via which a user can view at least some of the user-defined folders.

15. An information management system comprising:
at least one representations of information sources including graphic representation of check-update status; and
a check-update status maintainer operative to monitor the check-update status of each information source and to maintain the graphic representation of the check-update status accordingly.

16. An information management system comprising:
a search results GUI including a plurality of separate result windows for separate search results.

17. An information management system comprising:
a document portion identification GUI operative to allow a user to graphically identify a portion of a document using a targeted set of questions; and
a document portion processing unit operative to perform at least one process on a document portion defined by a user via the document portion identification GUI.

18. A system according to claim 12 which is operative to perform a search over a specific part of an information source.

19. An information management system comprising:
a plurality of information management tools;
an information source; and
a GUI (graphic user interface) integrating the plurality of information management tools around the information source using a graphical representation.

20. A system according to claim 1 wherein at least one of the information sources is selectably accessed via a locally stored copy thereof rather than directly.

21. A system according to claim 8 wherein the scheduling system performs the watch function over a user-defined set of information sources and over a user-defined time period.

22. A system according to claim 8 wherein the scheduling system comprises a notifier operative to notify a user of “hits”, the notifier employing any of a plurality of user-selectable notification modes.

23. An information management system comprising:
a watch unit operative to watch for a defined unit of information in a flow of information; and
an ELA unit.

24. A system according to claim 23 which is operative to perform an ongoing search over a specific part of an information source.

25. An information management system comprising:
an update checking unit; and
an ELA unit.

26. A system according to claim 25 which is operative to perform an ongoing update-check over a specific part of an information source.

27. A system according to claim 17 wherein the document portion processing unit is programmable to perform customized functions, thereby to allow a user to perform customized processes on specific document portions.

28. A system according to claim 14 wherein the client displays multiple sources simultaneously.

29. A system according to claim 14 wherein the client operates within a standard web browser without downloading and installing specialized software.

30. A system according to claim 16 wherein the search results GUI displays a list of results and, simultaneously, the results themselves in separate windows.

31. An information management system comprising:
a functional unit operative to perform a plurality of selectable functions on information; and
an automatic information retriever operative to, automatically retrieve information from a plurality of information sources.

32. A system according to claim 31 wherein the automatic information retriever is selectably operative to automatically retrieve information on a condition-triggered basis.

33. A system according to claim 31 wherein multiple user-selectable notification methods are employed to bring system work products to a user's attention.

34. A system according to claim 31 and also comprising an interface allowing mobile access to and control of the system.

35. An information management system comprising:
an information source processor operative for performing user-selectable information management processes on any user-selectable information source from among a plurality of information sources; and
an ELA interface constructed and operative to allow a user to identify specific elements of documents as information sources.

36. A system according to claim 35 wherein the specific elements which a user is allowed to identify include at least one of the following group: image, phrase, table, sub-table, line, caption, cell, row, column, item, list, paragraph, frame.

37. A system according to claim 35 wherein the ELA interface is operative to group several elements in a document.

38. A system according to claim 37 wherein the ELA interface is operative to contiguously group several elements in a document.

39. A system according to claim 37 wherein the ELA interface is operative to non-contiguously group several elements in a document.

40. A system according to claim 35 wherein a group of at least one elements may be identified by means of a combination of at least one internal properties.

41. A system according to claim 35 wherein a group of at least one elements may be identified by means of their relationships to other elements having a specified combination of at least one internal properties.

42. A system according to claim 40 wherein the internal properties include at least one of the following group: contains a specified text, possesses at least one descriptive formatting property, contains specified markup-tag information.

43. A system according to claim 42 wherein the at least one descriptive formatting property comprises at least one of the following group of property types: a color property, a size property, and a style property.

44. A system according to claim 41 wherein said relationships comprise at least one of the following type of relationships: after, before, between, contained in, location in group, bigger, biggest in group, first, smallest, largest.

45. A system according to claim 31 and also comprising an ELA unit.
